(19) United States
(12) Patent Application Publication
(10) Pub. No.: US 2016/0265321 A1
(43) Pub. Date: Sep. 15, 2016

(54) Well Pumping System Having Pump Speed Optimization

(71) Applicant: Encline Artificial Lift Technologies LLC, Houston, TX (US)

(72) Inventor: William G. Elmer, Tyler, TX (US)

(21) Appl. No.: 15/053,163

(22) Filed: Feb. 25, 2016

Related U.S. Application Data
(60) Provisional application No. 62/131,451, filed on Mar. 11, 2015.
(60) Provisional application No. 62/213,295, filed on Sep. 2, 2015.

(51) Int. Cl. E21B 43/12; G05B 19/042; F04B 49/20; E21B 41/00; F04B 47/02

(52) U.S. Cl. CPC E21B 43/121; E21B 41/0092; F04B 47/022; F04B 47/026; F04B 49/20; G05B 19/042; E21B 2043/125; G05B 2219/36292

(57) ABSTRACT

An oil well pumping system having stroke optimization is provided. The system includes a downhole pump residing within a wellbore, and a rod string extending down into the wellbore and connected to the pump. The system also includes a well head having an actuator configured to reciprocate the rod string and connected downhole pump as upstrokes and as downstrokes, and a pump stroke controller. The pump stroke controller is configured to adjust a speed of the upstroke and a speed of the downstroke in response to signals indicative of pump fillage. In one aspect, the pump stroke controller tunes the pumping speed to match an average in-flow of production fluids into the pump over a multiple hour period to provide an optimum speed. A method for optimizing pumping speed at a wellbore is also provided herein.

### CROSS REFERENCE TO RELATED APPLICATIONS

This application claims the benefit of U.S. Provisional Patent Appl. Ser. No. 62/131,451. That application was filed on Mar. 11, 2015 and is entitled “Well Pumping System Having Pump Speed Optimization.”

This application also claims the benefit of U.S. Provisional Patent Appl. Ser. No. 62/213,295. That application was filed on Sep. 2, 2015 and shares the same title.

Each of these provisional filings is incorporated herein in its entirety by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present disclosure relates to the field of hydrocarbon recovery operations. More specifically, the present invention relates to pumping systems for the production of hydrocarbon fluids, and to the optimization of operating speeds for a reciprocating downhole pump.

### TECHNOLOGY IN THE FIELD OF THE INVENTION

In the drilling of oil and gas wells, a wellbore is formed using a drill bit that is urged downwardly at a lower end of a drill string. After drilling to a predetermined depth, the drill string and bit are removed and the wellbore is lined with a string of casing. Particularly in a vertical wellbore, or the vertical section of a horizontal well, a cementing operation is conducted in order to fill or “squeeze” part or all of the annular area with columns of cement. The combination of cement and casing strengthens the wellbore and facilitates the zonal isolation, and subsequent completion, of certain sections of potentially hydrocarbon-producing pay zones behind the casing.

In completing a wellbore, it is common for the drilling company to place a series of casing strings having progressively smaller outer diameters into the wellbore. These include a string of surface casing, at least one intermediate string of casing, and a production casing. The process of drilling and then cementing progressively smaller strings of casing is repeated until the well has reached total depth. In some instances, the final string of casing is a liner, that is, a string of casing that is not tied back to the surface. The final string of casing, referred to as a production casing, is also typically cemented into place.

To prepare the wellbore for the production of hydrocarbon fluids, a string of tubing is run into the casing. A packer is set at a lower end of the tubing to seal an annular area formed between the tubing and the surrounding strings of casing. The tubing then becomes a string of production pipe through which hydrocarbon fluids may be lifted.

In order to carry the hydrocarbon fluids to the surface, a pump may be placed at a lower end of the production tubing. This is known as “artificial lift.” In some cases, the pump may be an electrical submersible pump, or ESP. ESP's utilize a hermetically sealed motor that drives a multi-stage pump. More conventionally, oil wells undergoing artificial lift use a downhole reciprocating plunger-type of pump. The pump has one or more valves that capture fluid on a down stroke, and then lift the fluid on the upstroke. This is known as “positive displacement.” In some designs such as that disclosed in U.S. Pat. No. 7,445,435, the pump is able to both capture and lift fluid on each of the down stroke and the upstroke.

Conventional positive displacement pumps define a barrel that is reciprocated at the end of a “rod string.” The rod string comprises a series of long, thin joints of solid rods (referred to colloquially as sucker rods) that are threadedly connected through couplings. The rod string is attached to a pumping unit at the surface. The pumping unit causes the rod string to move up and down within the production tubing to incrementally lift production fluids from subsurface intervals to the surface.

FIG. 1 is a somewhat schematic view of an oil well pumping system 100 as is known in the oil and gas industry. The oil well pumping system 100 is used for producing hydrocarbon fluids from a subsurface formation, and up to a surface 150 at a well site 110. Water, natural gas and other fluids may also be incidentally produced at the well site 110.

In FIG. 1, the illustrative oil well pumping system 100 is a so-called beam pumping unit. The beam pumping unit 100 includes a horse head 120 that reciprocates over a wellbore (partially shown at 170). The horse head 120 is connected to a walking beam 122. The walking beam 122, in turn, pivots about a fulcrum 124 in a cyclical manner.

The horse head 120 supports a polished rod 130. The horse head 120 and polished rod 130 are mechanically tethered by means of a harness system 135 (sometimes referred to as a “bridle”). Suitable packing is provided along the polished rod 130 to prevent production fluids from leaking out of the wellhead.

The polished rod 130 supports a plurality of so-called sucker rods 132 from the surface 150. Multiple sucker rod joints 132 extend down into the wellbore 170 in order to support the downhole pump (not shown). Each sucker rod is typically 25 to 35 feet in length, and resides within a string of tubing 145. The tubing 145, in turn, resides within strings of casing 125.

In order to induce reciprocation of the horse head 120 and connected polished rod 130 (and sucker rods 132 and downhole pump), a prime mover 140 is provided. In the illustrative system 100 of FIG. 1, the prime mover 140 is an electric motor that turns a rotating drive shaft. An example of a drive motor 140 is the Toshiba EQP Global electric motor. The Toshiba motor 140 and drive shaft transfer rotational motion to a pair of heavy, counter-weighted fly-wheels 142. The fly-wheels 142, in turn, are pivotally connected to pumping arms 144, or so-called “crank arms.” The pumping arms 144, finally, are pivotally connected to an end of the walking beam 122 that is opposite the horse head 120. Movement of the pumping arms 144 creates the reciprocating motion of the horse head 120 and suspended hardware. A further description of a walking beam unit is provided in U.S. Pat. No. 7,500,390 (issued to Weatherford/Lamb, Inc.), which is incorporated herein in its entirety by reference.

It is understood that the pumping system 100 of FIG. 1 is just one of several ways known for reciprocating sucker rods and a downhole pump from the surface 150. In many instances, the pumping unit operates using a combustion engine as the prime mover. In some instances, a hydraulic actuator system is used. Hydraulic systems employ an elongated cylinder that is positioned over a wellbore. The cylinder is axially aligned with the wellbore and houses a reciprocating piston. The cylinder cyclically receives fluid pressure through an external oil line. As fluid is injected through the oil line and into the cylinder under pressure, the piston is caused to move linearly within the cylinder. This, in turn, raises the connected rod string, causing the pump to undergo an upstroke. When fluid pressure is released from the cylinder, oil drains from the cylinder and the rod string is lowered due to gravitational forces, causing the connected downhole pump to undergo a downstroke.

Surface hydraulic actuator systems have been used successfully for many years. Such systems are ideal for urban environments where a small footprint is demanded. Further, such systems offer the ability to operate more than one well from a single surface pump.

Sucker rod pumping is the most widely used means for artificially lifting oil wells. Those of ordinary skill in the art will understand that, during reciprocation, the long sucker rod undergoes tension and compression forces, creating strain along the metal or fiberglass sucker rod string. Strain waves travel at the acoustical velocity in the rod material at about 16,000 feet/second. These strain waves can be detected at the surface 150 by means of a load cell, and converted into histograms. The histograms are presented, either physically or digitally, on so-called dynamometer cards The dynamometer cards are then analyzed to understand downhole operating conditions.

Early on, the polished rod dynamometer card was the principal tool for analyzing the operation of rod-pumped wells. The dynamometer is an instrument which records a curve of polished rod load vs. displacement. The shape of this curve is affected by the down-hole operating conditions. In the 1960's, research was conducted by engineers at Shell Oil Company (and its affiliated Shell Development Company) to create a computer-driven algorithm that diagnoses down-hole conditions independent of visual operator analysis.

The software-based diagnosis involved a viscous-damped wave equation:

$$\frac{{\partial }^{2} u}{\partial {t}^{2}} ( x , t ) = {v}^{2} \frac{{\partial }^{2} u}{\partial {x}^{2}} ( x , t ) - c \frac{\partial u}{\partial t} ( x , t )$$

$$or$$

$${v}^{2} \frac{{\partial }^{2} u}{\partial {x}^{2}} ( x , t ) = \frac{{\partial }^{2} u}{\partial {t}^{2}} ( x , t ) + c \frac{\partial u}{\partial t} ( x , t )$$

$$where v = \sqrt{144 {Eg}_{c} / p}$$

This is a second order partial differential equation having two variables, being time and space. The equation can be used to model the elastic behavior of a long, slender rod. Stated another way, the equation can describe the longitudinal vibrations of a rod pumping string so that polished-rod load and displacement can be determined. It is now understood that solving these equations ultimately allows the operator to adjust the speed of the upstroke and the downstroke of the sucker rods in order to optimize operation of the downhole pump.

An alternative detection technique has recently been developed for generating surface and downhole dynamometer cards. In lieu of load cells and wave equations, it is now known to analyze motor torque versus amperage, at least where an electric motor is being used. Either way, operators have begun using automated solutions for adjusting pump speed in order to increase hydrocarbon production at the surface. So-called pump-off controllers are available which operate in conjunction with a variable speed drive to optimize fluid production while protecting the pump. A rod pumping control unit (or “RPC”) is shown schematically in FIG. 1 at 200. The unit 200 is seen at the surface 150. The rod pumping control unit 200 includes a pump-off controller (seen in FIG. 2C at 250) that actively adjusts the pump rate to match the well's conditions. Pump rate is typically adjusted by increasing or decreasing amperage (or current) delivered to an electric motor. Of interest, the pump rate is typically adjusted on every stroke, meaning the multiple adjustments, large and small, are being made in any given day.

FIGS. 2A and 2B present perspective views of a known rod pumping control unit 200. The rod pumping control unit 200 includes a door 210, a housing 220 that supports the door 210 through hinges, and legs 225 that support the housing 220 above the surface 150. In FIG. 2A, the door 210 to the control unit 200 is closed. In FIG. 2B, the door 210 to the control unit 200 is open, revealing various electrical components. One such component is the pump-off controller 250. The controller 250 is shown supported by the door 210.

FIG. 2C is an enlarged perspective view of a pump-off controller 250 that electrically drives the rod pumping control unit 200. The controller 250 is also sometimes referred to as an RPC, or rod pump controller. The controller 250 includes circuitry (not shown) that resides within a sealed housing for implementing a control algorithm. The algorithm varies the speed of the pump in response to the amount of fluid produced from the pump. The controller 250 increases the pump speed in user-defined steps. For example, if a pump appears to have low pump fillage on a downstroke (as measured by the load cell), then a signal will be generated to decrease pump speed under the theory that the pump is trying to pump fluids too quickly. This decrease in pump speed reduces the pump output, which in turn should increase the pump fillage. When a decrease in speed does not produce a proportional increase in pump fillage, the rod pump controller 250 iteratively slows the speed until the desired pump fillage is achieved.

Reciprocally, if a pump appears to have complete pump fillage on a downstroke (as measured by the load cell), then a signal may be generated to increase pump speed. This enables the pumping system to capture more wellbore fluids each stroke. The rod pump controller 250 continually evaluates the pump fillage, generating speed increase/decrease signals as needed to keep the pump fillage within desired set-points.

A short-coming with known pump-off controllers 250 is that flow characteristics can mislead the controller 250 into making less than optimal speed changes. This is particularly true with horizontal wells, which are more and more becoming the standard completion arrangement in the United States. Known pump-off controllers are designed for vertical wells where fluid entry tends to be steady. In vertical wells, quick speed changes can result in a pump capacity equal to the well production. However, in a horizontal well, so-called slug flow will occur, causing alternating conditions of predominantly liquid and then switching to predominantly gas at the pump intake. This fools the controller 250 into making significant and unnecessary speed changes, going from a high speed to a lower or even minimum speed with every slug. This is hard on the pump and leads to pump slippage and early pump failure. Those of ordinary skill in the art will understand that replacing a downhole pump in a horizontally-completed well is not only expensive, but requires the well to be shut down for a period of time while maintenance is being conducted. This causes a loss of revenue as valuable hydrocarbon fluids are not being produced.

FIG. 3 is a Cartesian Coordinate 300 plotting pressure as a function of time in a horizontally-completed well. More specifically, graph 300 provides a graph of bottom hole pressure data from a horizontal well that was rod pumping in the vertical section. Bottom hole pressure (in psi) is shown in the y-axis, and time is measured (in minutes) along the x-axis. Note that the time scale from beginning to end is only 72 minutes.

As shown in graph 300, pressure was measured at the pump intake, shown along line 310. Separately, pressure was measured along the lateral (or horizontal) leg of the wellbore, shown along line 320. The difference in these pressure readings is shown at line 330. As can be seen, line 330 is not linear, but is more sinusoidal.

The typical behavior of horizontal wells is to create slugs of fluid, followed by a “blow down” period of gas. For one observed well, this occurred about every 15 minutes. The large difference observed in line 330 means that the pipe between the two gauges was predominantly liquid-filled, which weighs more than gas. During times shown where the differential line 330 is rising (positive slope), liquids are beginning to fill the curved section (or heel) of the wellbore from the lateral leg to the pump intake. During this time, gas is trapped in the lateral leg, typically at some higher elevation point. Finally, once this trap is gas filled, it begins to escape, pushing the liquid ahead of it. The gas will “exhaust” fairly quickly, as evidenced by the sharp drop after each peak (where the sign of the slope of the line changes), in comparison to the slow incline before each peak in line 330.

When the gas being held back in “high spots” of the horizontal portion of the wellbore begins to expand, it first pushes liquids from the remainder of the horizontal wellbore up into the vertical section where the pump is located. The normal pump-off controller 250 will correctly calculate high pump fillage, and start running the pumping unit incrementally, i.e., with each cycle, faster until reaching its maximum allowed speed which has been pre-set in the algorithm. When the gas arrives, the pump-off controller 250 will correctly calculate poor pump fillage, and decrease speed very rapidly, e.g., with each cycle, as poor pump fillage is detrimental to the mechanical life of the rod pumping system. The controller 250 may drop the pumping speed all the way down to a pre-set minimum pumping speed. The result can be an extreme amount of cycling between maximum and minimum speed set-points for the pump-off controller 250, never converging on an ideal speed.

It is also observed that existing rod pump control units 200 are not optimized to reduce pump slippage. Pump slippage may be caused by traveling valve leakage, which occurs when production fluids slip past the traveling valve ball, back into the pump, or by a worn pump barrel or plunger, where production fluids slip between the barrel and plunger back into the pump. In either instance, pump slippage occurs on the upstroke, typically due to wear and tear from excessive cycling.

Accordingly, a need exists for an improved pump speed controller (or “optimizer”) for a subsurface rod pump that tunes the pumping unit speed to match the average in-flow over a multiple hour period, thereby providing an ideal speed for a designated period of time. A need further exists for an improved pump speed controller that is able to intercept a control signal provided by an existing rod pumping control unit, and tune that speed to increase pump fillage while, optionally, decreasing pump stroke speed.

### BRIEF SUMMARY OF THE INVENTION

An oil well pumping system is first provided herein. The pumping system first includes an elongated string of sucker rods. The sucker rods extend down into a wellbore. Preferably, the wellbore is completed to have a substantially horizontal section, but the rod string only extends down the vertical portion of the wellbore. The rods may be of any diameter and construction.

At a lower end of the sucker rods and within the wellbore is a pump. The downhole pump may also be of any design, so long as it is configured to capture wellbore fluids upon reciprocation by the sucker rods.

The pumping system has an actuator for moving the rod string and connected pump. The actuator may be a mechanically-based system. In this instance, a so-called walking beam mechanically moves a polished rod and connected sucker rod string up and down within the wellbore in cycles. This motion is typically in response to circular motion of a fly-wheel, induced by a prime mover. The prime mover is a motor, which may be powered by electricity, or may be powered by a combustion engine.

Alternatively, the pumping system may be a hydraulic system. In this instance, hydraulic fluid cyclically acts upon a piston connected to the polished rod within a fluid-sealed chamber. Injecting fluid, such as a clean oil or a refined oil, into the chamber causes the piston and connected polished rod to rise above the wellbore. Conversely, releasing fluid from the chamber and back to a reservoir causes the piston and connected polished rod to fall within the chamber as oil flows back into the reservoir. The prime mover in this instance is preferably an electric motor that acts upon a compressor, or fluid pump.

In either instance, the prime mover is at a surface and resides proximate a wellhead. Reciprocation of the polished rod and connected rod string and downhole pump causes reservoir fluids to be produced from a wellbore and up to the surface through positive displacement. Preferably, the rod string resides within a string of production tubing which transports production fluids to the surface.

The rod string and connected downhole pump generally move together between upper and lower pump positions. This creates an upstroke and a downstroke for the pump.

The pumping system also includes a pump stroke controller. The pump stroke controller is configured to adjust a speed of the upstroke and a speed of the downstroke of the pump in response to signals indicative of pump fillage. The pump stroke controller is configured to “tune” the pumping speed of the well according to a calculated average in-flow of production fluids over a period of time to provide an optimum speed. Preferably, the period of time is in excess of one hour. More preferably, the period of time is in excess of four hours, such as once every six hours or once every eight hours.

The pump stroke controller is primarily designed to address the problem of so-called slug flow found in horizontal wells. Slug flow occurs when gas invades the horizontal portion of the wellbore, and accumulates. The gas tends to release at one time, creating an event where the downhole pump fails to fill with hydrocarbon fluids on an upstroke. This causes a conventional pump-off controller at the well to send a signal to the actuator to rapidly draw down pump speed towards a minimum working speed.

In one aspect of the invention, the pump stroke controller, or optimizer, is separate from a previously-installed pump-off controller in place at the wellhead. In operation, the pump-off controller sends first pump speed control signals intended for the actuator in response to pump fillage. The pump stroke controller is configured to intercept the first pump speed control signals as value V, and process value V to generate a second pump speed control signal (Av) that tunes the upstroke (U) and downstroke (D) pumping speeds to provide a more ideal, or optimized, pump cycle. The control signal (Av) may represent an average Hertz value over the multiple-hour period of time, or a speed that results in a certain number of slug flow events over the multiple-hour period. Pump speed adjustments may be made, for example, once every six hours rather than on every stroke as with known pump-off controllers.

In one aspect, the previously installed pump-off controller has pre-set values of maximum working speed X and minimum working speed Y. The well pumping system may be run for a period of time, such as at least 24 hours, to observe pumping speeds governed by the on-site pump-off control unit and to ascertain the X and Y speeds. This is referred to as a startup period. In one aspect, the pump stroke controller then sets the upstroke speed U of each cycle at [X−Av], or at some adjusted amount H below [X−Av]. In one aspect, the downstroke control speed D is then set at an amount Z below U, or an amount Z below the adjusted amount H. Preferably, D is never less than Y.

In one aspect, the pump stroke controller counts a frequency of minimum speed events (MSE). An MSE may be defined as an event where both the upstroke speed U and the downstroke speed D have been reduced to the pre-set minimum working speed Y. MSE's are indicative of low pump fillage. The pump stroke controller further tunes the pumping speed to provide the optimum pump speeds by utilizing the adjustment value H to incrementally adjust pump speed.

The adjustment value H may be calculated by:
counting an actual number E of Minimum Speed Events (MSE);
receiving an input for the desired number B of Minimum Speed Events (MSE);
comparing the value E to value B a set number of times each day;
multiplying the difference between E and B by a pre-set gain variable F to reach a value H, wherein H=(E−B)×F; and
setting value U at [X−Av]−H).

Thus, for example, if the upstroke U is set at 40 and value H is 10, then the upstroke speed U will be reduced to 30. Further, if input Z is set to 24, then downstroke speed D will be set to the greater of 6 (that is, 30−24) or the minimum working speed Y, until the next Av is determined. Providing that pump fillage as judged by the pre-existing pump-off controller is above the desired set point, which would mean that a minimum speed event is not in progress, the pump speed controller will then run the upstroke and downstrokes at these new speeds U and D for six hours, until a new Av and, optionally, a new H is set.

A method for optimizing pumping speed at a wellbore is also provided herein. The method employs the pump stroke controller, or optimizer, described above. Preferably, the pump stroke controller is employed in connection with a horizontally completed well to overcome a problem of gas-induced slug flow. Separate pumping speeds U and D are set at designated intervals based on an average pumping speed Av calculated by the pump stroke controller over a multi-hour period.

A method of operating a well is also provided. The method includes providing a fluid pumping system for the well. The fluid pumping system is used for the production of hydrocarbon fluids from the wellbore. The pumping system includes a pump stroke controller as described above.

Using the pump stroke controller, first signals V are received from an existing pump-off controller at the well-site that are indicative of pump fillage. In response to these first signals V, the method then includes periodically generating second signals Av using the pump stroke controller that adjust a speed of the upstroke U, a speed of the downstroke D, or both, of a pump to maintain pump fillage at a desired set point. In this method, the second signals Av represent an average pump speed, or an average in-flow of fluids into the pump over a period of time, that is at least one hour. Preferably, the period of time is in excess of two hours, such as once every four hours, or once every six hours, or once every eight hours.

In on embodiment, the upstroke speed U is set at Av. In a preferred embodiment, the upstroke speed U is set at [X−Av], and the downstroke speed D is set at an amount Z below U, but not less than a pre-set minimum speed Y. In one aspect, a further adjustment is made to the second control signals Av at designated intervals. In this respect, a value H (calculated as shown above) is applied to reduce upstroke speed value U by adjustment value H, where U at [X−Av]−H. Preferably, value D is maintained at a minimum working speed Y.

As part of operation of the controller, speed signals V are intercepted from a previously-installed pump-off controller. Intercepting the signals V may comprise (i) removing an analog output wire from the rod pumping control unit, and connecting the output wire to an input bus in the pump stroke controller; or (ii) detecting first control signal values V at a ModBus Ethernet connection from the rod pumping control unit, and re-routing the first control signal values V to the pump stroke controller.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a somewhat schematic view of an oil well pumping system as is known in the oil and gas industry. The oil well pumping system is used for producing hydrocarbon fluids from a subsurface formation, and up to the surface at a well site.

FIGS. 2A and 2B present perspective views of a known pumping control unit. In FIG. 2A, a door to the unit is closed. In FIG. 2B, the door to the unit is open, revealing components including a pump-off controller.

FIG. 2C is an enlarged perspective view of a known pump-off controller.

FIG. 3 is a Cartesian Coordinate plotting bottom hole pressure as a function of time in a horizontally-completed well.

FIG. 4 is a schematic view of a printed circuit board and associated hardware, firmware and circuitry for a new pump stroke controller, or optimizer, in accordance with the present invention, in one embodiment.

FIGS. 5A and 5B present a unified flow chart for steps used in optimizing pump stroke speed in a fluid pumping system of the present invention, in one embodiment. The steps improve the operation of a known pump-off controller by providing a speed detection module, an upstroke module, a downstroke module and a speed adjustment module.

FIG. 6 is a flow chart presenting steps for operation of the upstroke speed module of FIG. 5B.

FIG. 7 is a flow chart presenting steps for operation of the downstroke speed module of FIG. 5B.

FIG. 8 is a flow chart presenting steps for operation of the speed detection module of FIG. 5A.

FIG. 9 is a flow chart presenting steps for iteratively adjusting pump speed of FIG. 5A. This is the speed adjustment module of FIG. 5A, in one embodiment.

FIG. 10 is a screen shot of an illustrative web page showing operating conditions of the pump stroke controller.

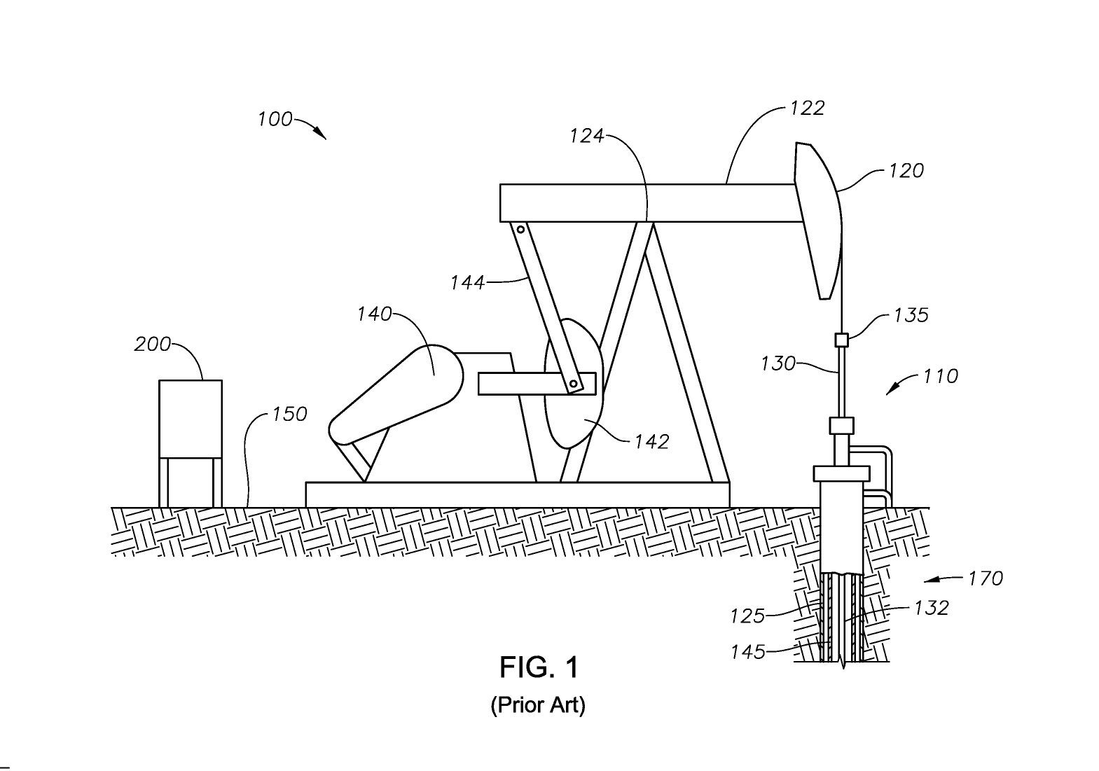

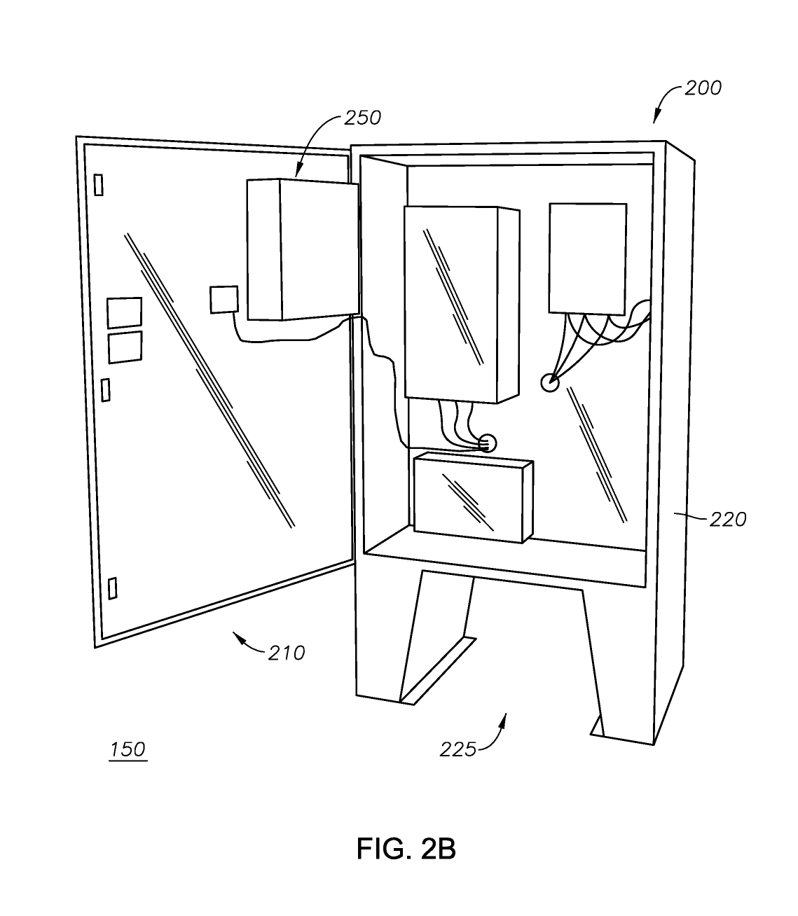

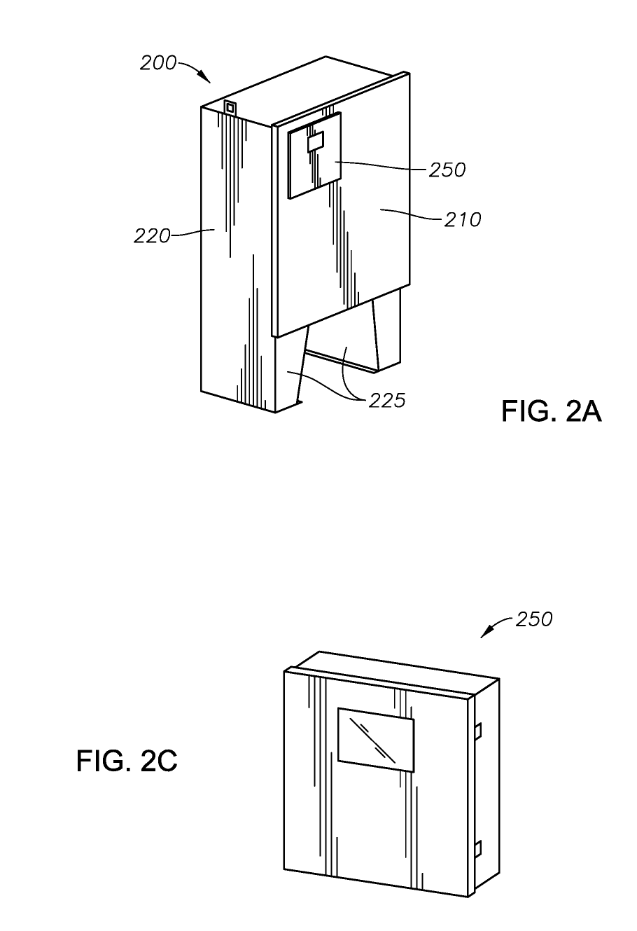

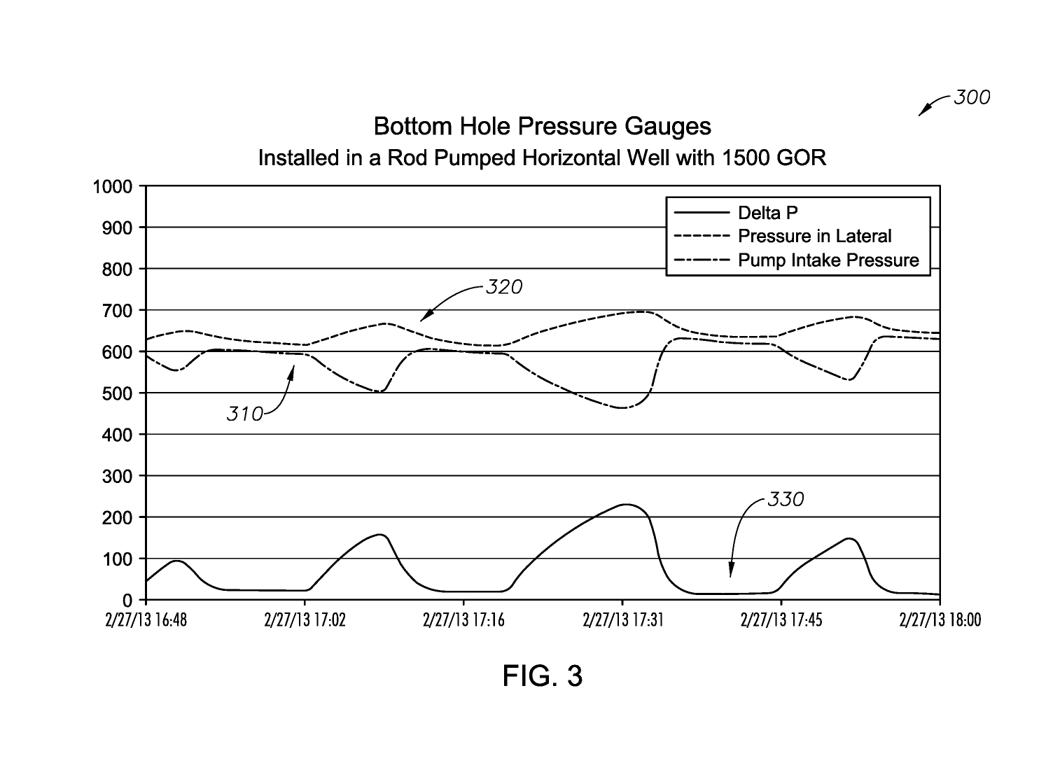

### DETAILED DESCRIPTION OF CERTAIN EMBODIMENTS

### Definitions

For purposes of the present application, it will be understood that the term “hydrocarbon” refers to an organic compound that includes primarily, if not exclusively, the elements hydrogen and carbon. The term hydrocarbon fluids may include other elements, such as, but not limited to, halogens, metallic elements, nitrogen, oxygen, and/or sulfur.

As used herein, the term “hydrocarbon fluids” refers to a hydrocarbon or mixtures of hydrocarbons that are gases or liquids. For example, hydrocarbon fluids may include a hydrocarbon or mixtures of hydrocarbons that are gases or liquids at formation conditions, at processing conditions or at ambient condition. Hydrocarbon fluids may include, for example, oil, natural gas, coalbed methane, shale oil, pyrolysis oil, pyrolysis gas, a pyrolysis product of coal, and other hydrocarbons that are in a gaseous or liquid state.

As used herein, the terms “produced fluids,” “reservoir fluids” and “production fluids” refer to liquids and/or gases removed from a subsurface formation, including, for example, a shale formation or an organic-rich rock formation. Produced fluids may include both hydrocarbon fluids and non-hydrocarbon fluids. Production fluids may include, but are not limited to, oil, natural gas, pyrolyzed shale oil, synthesis gas, a pyrolysis product of coal, carbon dioxide, hydrogen sulfide and water (including steam).

As used herein, the term “fluid” refers to gases, liquids, and combinations of gases and liquids, as well as to combinations of gases and solids, combinations of liquids and solids, and combinations of gases, liquids, and solids.

As used herein, the term “wellbore fluids” means water, hydrocarbon fluids, formation fluids, or any other fluids that may be within a string of drill pipe during a drilling operation.

As used herein, the term “gas” refers to a fluid that is in its vapor phase at in situ conditions.

As used herein, the term “subsurface” refers to geologic strata occurring below the earth's surface.

As used herein, the term “formation” refers to any definable subsurface region regardless of size. The formation may contain one or more hydrocarbon-containing layers, one or more non-hydrocarbon containing layers, an overburden, and/or an underburden of any geologic formation. A formation can refer to a single set of related geologic strata of a specific rock type, or to a set of geologic strata of different rock types that contribute to or are encountered in, for example, without limitation, (i) the creation, generation and/or entrapment of hydrocarbons or minerals, and (ii) the execution of processes used to extract hydrocarbons or minerals from the subsurface.

As used herein, the term “wellbore” refers to a hole in the subsurface made by drilling or insertion of a conduit into the subsurface. A wellbore may have a substantially circular cross section, or other cross-sectional shapes. The term “well,” when referring to an opening in the formation, may be used interchangeably with the term “wellbore.” The term “bore” refers to the diametric opening formed in the subsurface by the drilling process. (Note that this is in contrast to the term “cylinder bore” which may be used herein, and which refers to a hydraulic cylinder over a wellbore.)

### Description of Selected Specific Embodiments

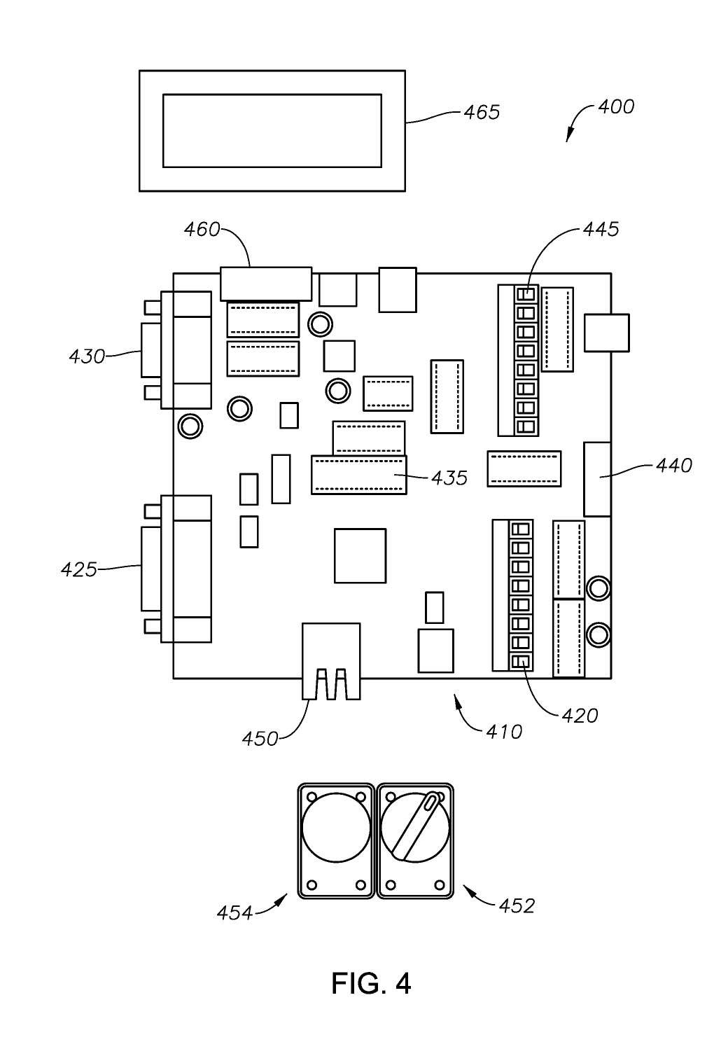

FIG. 4 is a schematic view of a pump stroke controller 400 of the present invention, in one embodiment. As shown in FIG. 4, the pump stroke controller 400 defines a printed circuit board with associated hardware, firmware and circuitry. In one aspect, the pump stroke controller 400 includes an embedded programmable logic controller (or “PLC”). The PLC may be, for example, the FMD88-10 PLC which offers an open board design, combined with Ladder+ BASIC programming software. The controller may also be referred to herein as a micro-processor.

In one aspect, the pump stroke controller 400 receives signals indicative of pump fillage at the surface. In one aspect of operation, those signals are generated by a separate pump-off controller 250 at the well site, processed to provide control signals V that adjust pump speed. The pump stroke controller 400 intercepts the output signals V of the pump-off controller 250. Those signals are then processed to generate more desirable, or “tuned,” output signals U (for upstroke speed) and D (for downstroke speed). Preferably, the tuned signal is based on an averaging of the signals V over a multi-hour period of time, such as six hours.

In practice, the pump stroke controller 400 will be held in a sealed housing with an appropriate wiring manifold and power source (not shown). The pump stroke controller 400 may be supported on a rod pumping control unit, such as unit 200, by hardware such as bolts, or by magnets.

Various components of the pump stroke controller 400 are indicated in FIG. 4. These include a printed circuit board 410, digital inputs (or pins) 420 with high speed counter, analog input/output card 425, and a bus port 430. The pump stroke controller 400 also includes an optional expansion port 440 and digital outputs 445. Finally, the pump stroke controller 400 is built with an LCD interface 460 and optional display 465. Alternatively, the pump stroke controller 400 may use a web page for remote user interface.

The analog input/output card 425 is preferably a 10-channel AIO Terminal Strip card. The card 425 is designed to connect easily to a FMD or F-series PLC DB15 analog port and provides screw terminal connection for simplified wiring for all 8 analog inputs and up to 4 analog outputs.

The bus port 430 is preferably an RS232 HostLink and Modbus port. This provides another option for connecting to an external device, using Modbus protocol. Modbus is a popular language protocol in the oil and gas industry. Using a USB to RS232 serial port adapter, communication may be established between the PLC and a laptop PC using a Triangle Research program TL Server. The Triangle Research i-Trilogi TL6 programming software then communicates with the PLC, numbering the PLC, and setting up an initial IP address for the LAN where the pump stroke controller 400 set-up is occurring.

Operations software is downloaded into the PLC, and an internal clock on the PLC is also set. An Ethernet port 450 is provided that can connect to other devices or web servers for control or data up/down loading.

The pump stroke controller 400 will also include a memory module 435. In one aspect, the memory module 435 is a ferromagnetic random access memory card. The card may be, for example, the FRAM-RTC-256 module from Triangle Research. This card has a set of 2×5 header pins which are plugged into a CONN1 connector on the PLC. A nylon standoff is included to provide the support on a side of the FRAM-RTC board. The card is able to store large amounts of data should such be desired for data logging. It also allows for learned values about optimum pump speeds in the event of power failures.

The pump stroke controller 400 will also include an on-off selector switch 452. This switch 452 may be, for example, the Automation Direct GCX Series Selector Switch, Model GCX1300. A contact block for the GCX switch will also be included. The selector switch 452 is connected to shielded wires each containing two 18-gauge conductors, which are in turn connected to the pump stroke controller's digital inputs 420 and outputs 445.

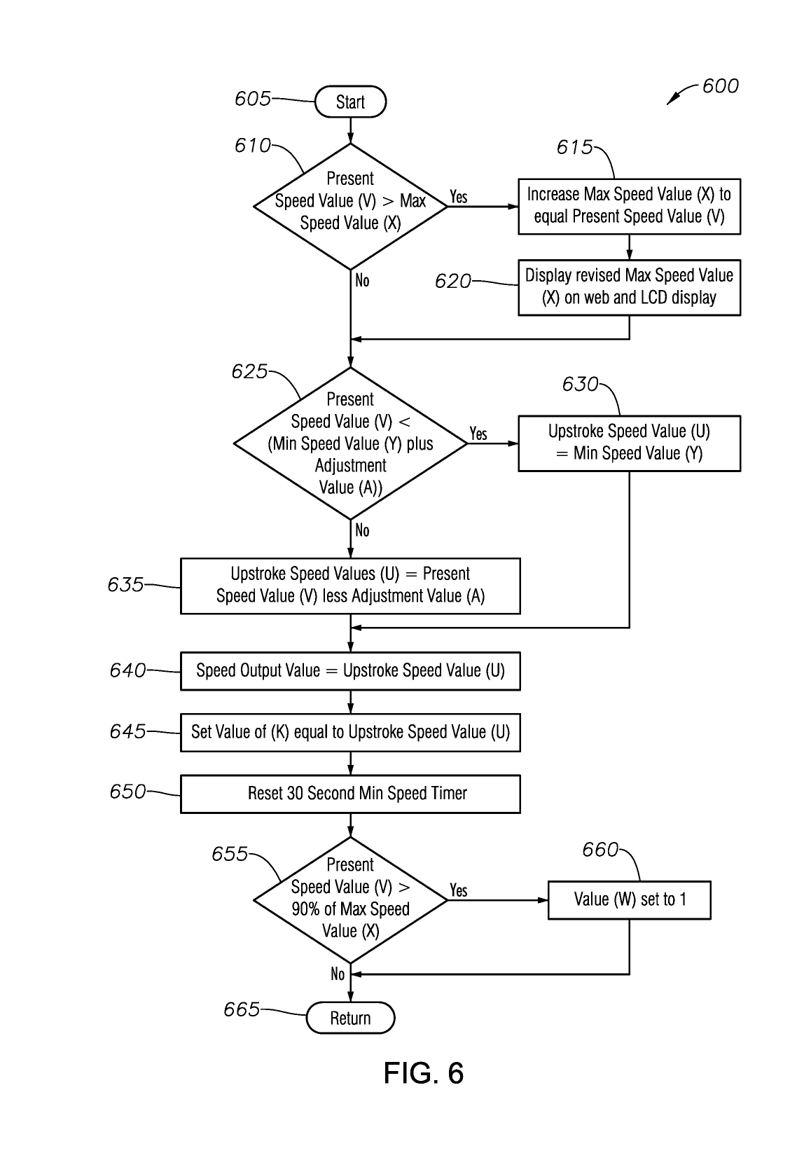

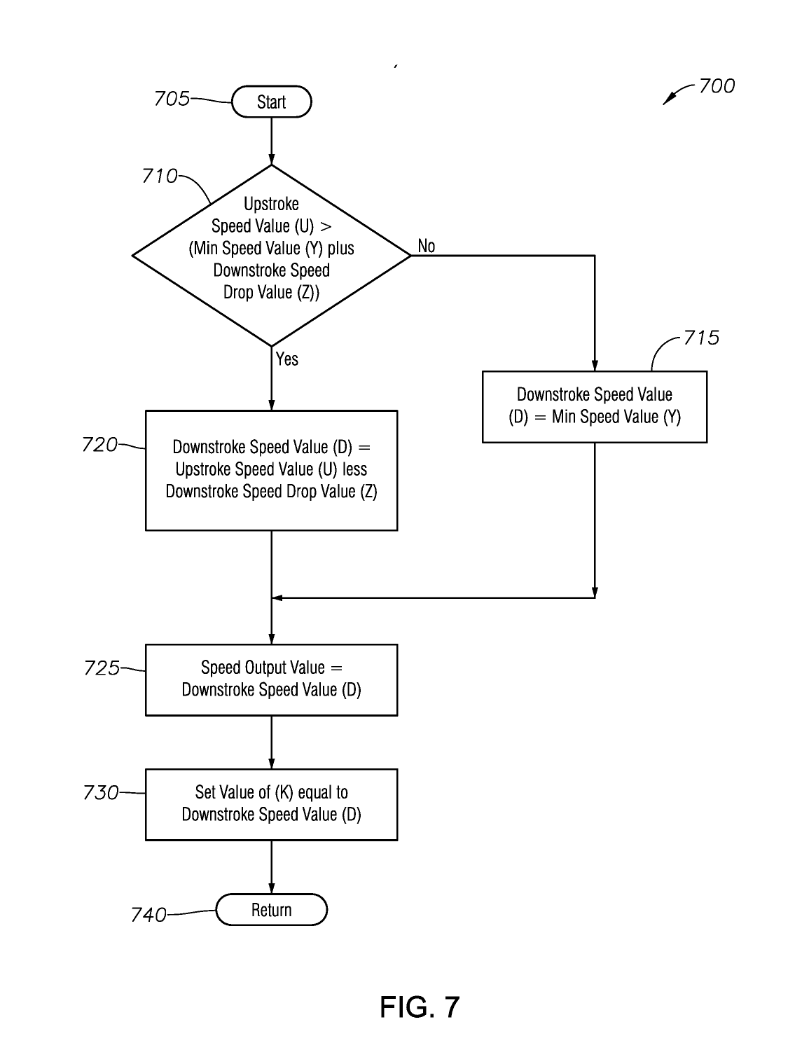

When in the OFF position, the On-Off switch 452 will keep the pump stroke controller 400 from operating. In this condition, the rod pumping control unit 200 will behave as if there were no pump stroke controller 400. In the ON position, it will allow the pump stroke controller 400 to detect maximum X and minimum Y rod-pump controller 250 speed set points in accordance with the routines of FIGS. 6 and 7, as well as when the upstrokes and downstrokes are occurring. In operation, the pump stroke controller 400 will intercept the speed signals V output from the pump-off controller 250, and deliver a more desirable speed signal output to the Toshiba Global drive motor 140.

In one embodiment, the pump stroke controller 400 also includes a push-button operated momentary switch 454. This may be, for example, the Automation Direct Model GCX1100. This is a push-button 22 mm diameter metal switch with 30 mm head. A corresponding legend plate may be included. A pair of shielded wires connect it to the pump stroke controller's digital inputs 420 for manually setting of certain process set points.

The push-button switch 454 has two functions. First, when the On-Off switch 452 is in the ON position, holding the pushbutton switch 454 down will instigate a buzzer countdown of the present value of B. (Value B represents a desired number of Minimum Speed Events as described further below.) After the push-button switch 454 has been held and a desired number of beeps has been heard, the countdown will stop and the value of B has been set. The operator may optionally repeat this process at a later time to attain a new value B. In one embodiment, the operator holds the push-button switch 454 down for a total of 10 or more seconds, and a buzzer will resume beeping. The operator may count the beeps until the desired number (or value B) has been reached, and release the button immediately after the desired number has been completed. If the Value B is set above 10, this will cause the dominant algorithm to be changed from an MSE based algorithm to an Average Speed based algorithm.

The second function of the push-button switch 454 is optionally to reset the learned “Maximum Working Speed” X and “Minimum Working Speed” Y, as defined by the pump control unit 200 operator. These can be manually reset through the pump-off controller 250 display, or via XSPOC which is a known industry rod pump controller management software package. However, the pump speed controller 400 has no way to know if this has been done. In one aspect, the pump speed controller 400 will adapt to increases in the maximum working speed X, but not to decreases. It will also not adapt to changes in the minimum working speed Y. Therefore, it is recommended that these values not be changed from certain defaults, as program confusion could result. Preferably, the default minimum working speed Y should be no more than 25% of the maximum working speed X.

There are three ways to reset the above speeds. First, the operator may turn the pump-off controller 250 On-Off switch (not shown) to the OFF position, and hold the push-button switch 454 in for, for example, 8 seconds. The operator may then release the push-button switch 454, and turn the On-Off switch of the rod pump controller 250 back to the ON position. This may be done when the pumping unit is expected to reach the “Maximum Working Speed” after the start-up strokes have completed. In this way, the pump-off controller 250 reverts to the original maximum working speed.

Second, the operator may toggle Reset X and Y buttons by using a custom 0.HTM webpage. Third, the operator may input values X and Y through a Triangle PLC on-line monitoring feature.

In one embodiment, the pump stroke controller 400 is designed to fit inside the housing 220 of a pre-installed pump control unit 200, such as the Lufkin Well Manager™ or the Weatherford Well Pilot™. Preferably, the pump stroke controller 400 is incorporated into the Lufkin Well Manager™ variable speed drive unit (or the Weatherford Well Pilot™ drive unit) having a housing 220 (or cabinet) that also houses a Toshiba VFD motor 140. The pump stroke controller 400 may operate from the same power supply as the pump control unit 200.

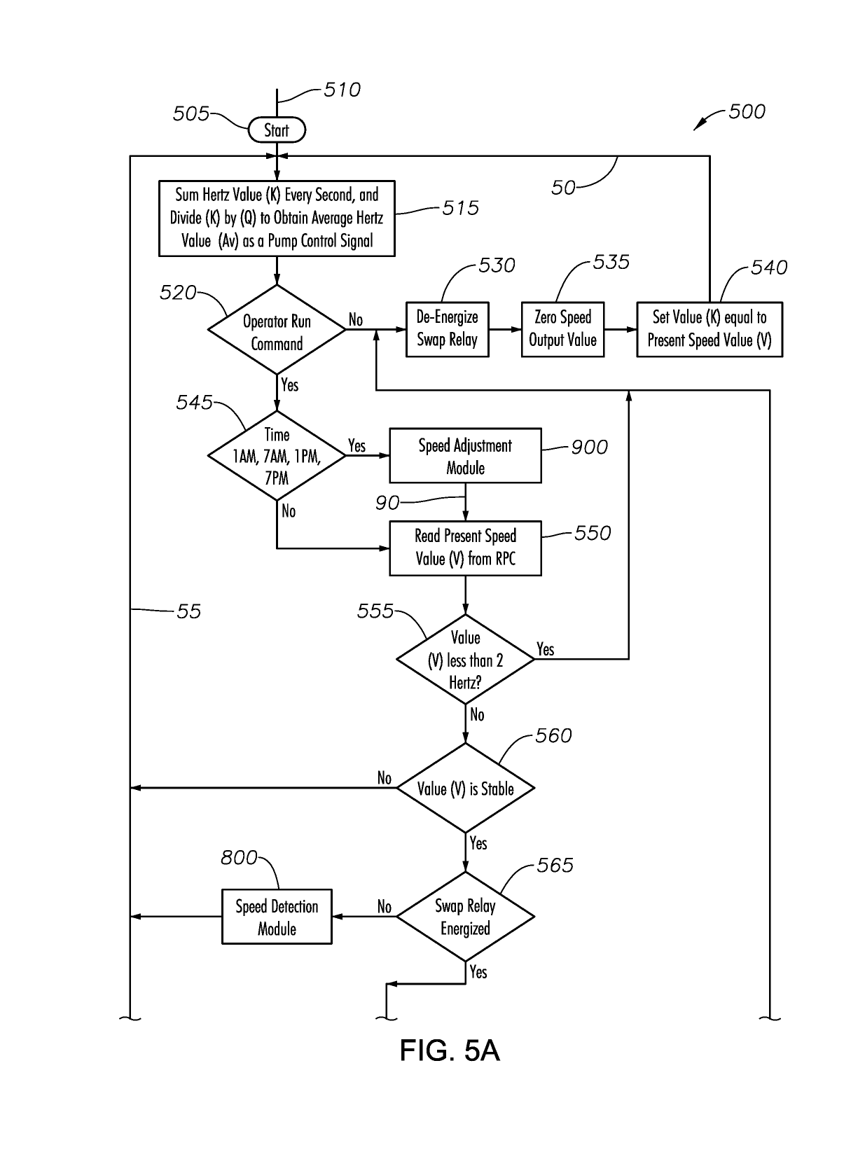

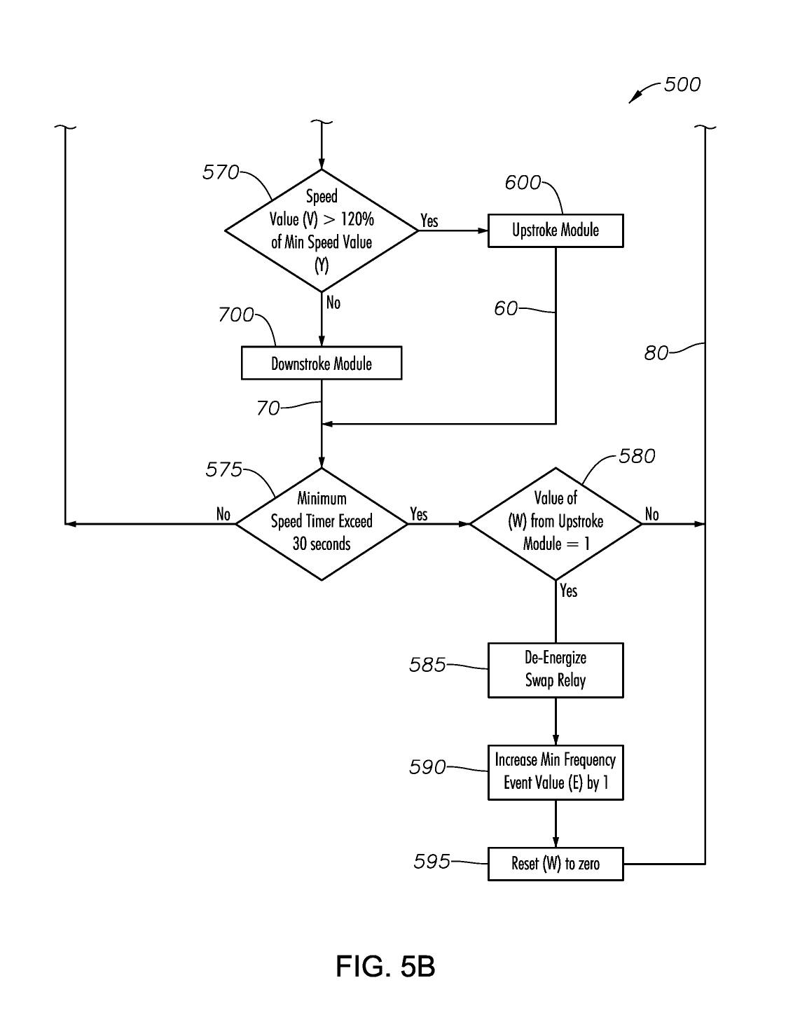

FIGS. 5A and 5B present a unified flow chart 500 for steps used in optimizing pump stroke speed in a fluid pumping system of the present invention, in one embodiment. The steps improve the operation of a pump-off controller 250 (also known in the industry as a rod pump controller, or RPC) by providing an upstroke module 600, a downstroke module 700, a speed detection module 800 and a speed adjustment module 900. The flow chart 500 assumes the use of the pump stroke controller 400 of FIG. 4, along with the preferred FMD10-88 programmable logic controller. The purpose of the steps in the flow chart 500 is to periodically generate an adjusted speed signal for a prime mover, such as the Toshiba VFD motor 140.

FIG. 5A indicates a Start 505. At this point, pump speed output signals V from a rod pump controller 250 are intercepted. This is preferably done by taking an analog output signal wire (shown schematically at 510) from the rod pump controller 520, and connecting the wire 510 to an input bus associated with one of the digital inputs 420 on the board 410. The signal V is measured in Hertz. In one aspect, the V values are the current (or present) output voltage values going to the Toshiba drive 140, converted into Hertz by a 45.5 factor. Note that in the controller 400, 10 volts corresponds to 90 Hertz, and a program value of 4,096. Hence, the value of 45.5 is obtained by dividing 4,096 by 90.

The controller 400 takes multiple signal readings V, preferably at least one per second, and optionally at least twenty per second. The signals V represent voltage, but are indicative of pump fillage, which is deduced from rod load measurements—as will be understood by those of ordinary skill in the art. Those of ordinary skill in the art will also understand that a higher pump fillage requires a higher voltage to move the rod string and connected pump, while a lower pump fillage requires a lower voltage to move the rod string and connected pump. In any instance, the controller 400 sums the output voltage values V to produce a total Hertz value K. K is the sum of all the rod pump controller output voltages V to the Toshiba VFD drive 140 over a designated period of time Q, such as six hours. Value Q may be the number of minutes, or the designated period of time, as shown at Box 515, to produce an average value Av. In one aspect, K is the running sum of the average Hertz per minute over a 6 hour period, averaged in CusFn 21 by Q to produce a new average Hertz value Av.

It is observed here that there are numerous ways to calculate an “average” of speed readings besides the so-called arithmetic mean. The term “average” herein is intended to encompass not only a straight average of voltage values over time, but averages of two or more averages taken over various times, moving averages, means of voltage readings (including harmonic means and trimmed means), and smoothed averages. The term “averaging of pump speed data” herein is not limited to one particular method, but includes any mathematical model for measurement of central tendency. Further, the present inventions are not limited to any particular manner of determining an average value for first control signals V unless expressly so stated in the claims.

An Operator Run Command decision is made. This is shown at Query 520. The Run Command is “No” if the ON-OFF switch 452 is in its off position. If the Run Command is “No,” a signal is sent to a De-Energize Swap Relay node, seen at Box 530. A Zero Speed Output Value is then set, as shown at Box 535. Value K is then set to be equal to the present speed value V so no speed adjustment is made. This is provided at Box 540. In this instance, no change is made to the control signal V sent by the rod pump controller 250 through wire 510 (or, alternatively, through a Mod Bus) and the pumping unit 100 operates as if the controller 400 was not present. The controller 400 returns to Start 505 as shown at Line 50.

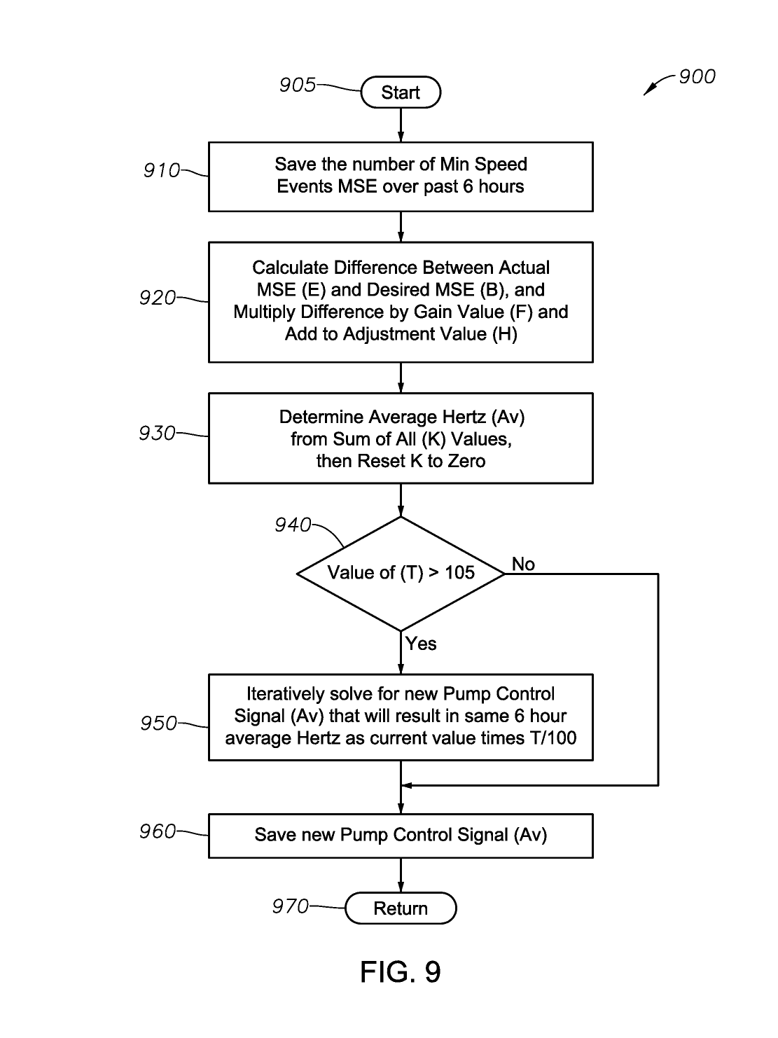

If the Run Command is “Yes,” this means that the ON-OFF switch 452 is in its “On” position. The controller 400 determines if the clock indicates an appropriate time for making a speed adjustment. This is provided at Query 545 In the illustrative arrangement of FIG. 5A, speed adjustments are made four times per day, such as at 1:00 am, 7:00 am, 1:00 pm and 7:00 pm. If one of these times is detected, then a speed adjustment takes place in accordance with module 900 (described below in connection with FIG. 9).

It is understood here that the times and schedule shown in Query 545 are merely illustrative. Averages and speed adjustments may be made more frequently or less frequently then every six hours, and at different times. For example, averages may be taken over eight hour periods, and speed adjustments made at 8:00 am, 4:00 pm and 12:00 am each day. Alternatively, averages and/or speed adjustments may be taken every four hours.

If one of the selected times in Query 545 is not detected, then the controller 400 will read the present speed value V from the RPC 250. This again is the value V taken from the analog output signal wire 510, and indicated at Box 550. If that value V is less than a small, pre-selected value, such as only 2 Hertz, then the controller 400 will infer that the rod pump controller 250 itself has been turned off and the present speed value V will be maintained. This is provided at Query 555.

If the value V is above the small, pre-selected value set in Query 555, then the controller 400 will continue operation. A determination is optionally made as to whether the value V is “stable.” This is shown at Query 560. This determination may be done, for example, by confirming that two or more substantially similar V values are consecutively recorded. Alternatively, 3 or 4 consecutively recorded signals may be averaged, and then that average value may be compared to another average determined from another set of 3 or 4 consecutively recorded signals, with the averages being compared to determine if they are within a desired value V proximity. It is understood that other techniques may be used to determine if value V is stable, such as determining whether two or more consecutive values of V are the same, wherein value V is calculated by dividing V by 50, and then converting the quotient to an integer. For purposes of the present disclosure, this is the same as comparing V values. In any instance, if the value V is deemed unstable, then the controller 400 re-starts operation and no adjusted speed signal Av is generated. This is shown at Line 55.

If the value V is deemed stable, then the system is queried to see if the Swap Relay 870 is energized. This is presented at Query 565. The Swap Relay 870 may be an actual relay that physically re-connects the input signal V from the pump-off controller 250 to the Toshiba VFD motor 140. More preferably, a true ON-OFF switch is used to prevent the momentary interruption in the speed input signal in the micro-second that the contacts go from the pump-off controller 250 to the rod pump controller 400 for controlling the Toshiba VFD motor 140.

If the Swap Relay 870 is not energized, such as when the pump is running at or below minimum speed such that the controller 400 is unable to detect whether the pumping system is on its upstroke or its downstroke, then a speed detection module is activated. This is shown at Box 800. The purposes of the speed detection module 800 are (1) for the controller 400 to learn what the minimum and maximum working speed settings in the rod pump controller 250 are, and (2) to energize the Swap Relay 870 when it detects the conclusion of a MSE, as recognized by the signal V exceeding the value of Y by 20% or more. The minimum and maximum working speeds are designated as Y and X, respectively. If the Swap Relay 870 is energized, then the flow chart 500 moves on to Query 570, discussed below.

When a Minimum Speed Event has occurred (such as may be detected when a minimum speed event timer reaches 30 seconds), the pump-off controller 250 will send a steady minimum speed signal Y. In this instance, the controller 400 has no way to tell when the pumping unit is on its upstroke or its downstroke, and the Swap Relay is de-energized. This causes a “mimic” operation to resume. This also sets the value of D equal to Y. Not until the processor 400 sees a voltage signal V that exceeds a certain percentage will the swap relay be re-energized.

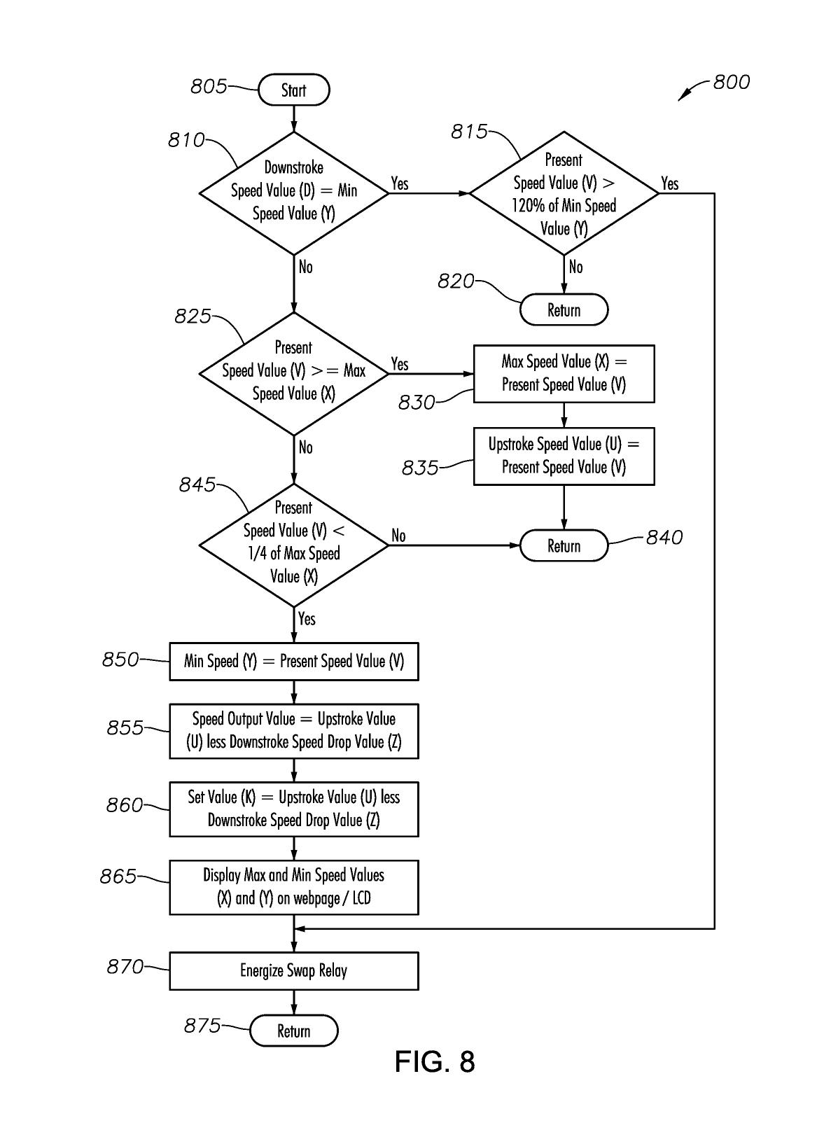

Processing steps for the speed detection module 800 are presented in detail, in one embodiment, in FIG. 8. The purpose of the speed detection module 800 is to detect changes in voltage indicative of upstrokes and downstrokes. FIG. 8 is a flow chart presenting steps for operation of the speed detection module 800. As can be seen in FIG. 8, the speed detection module 800 has a representative Start, shown at Box 805. This means that a present voltage value V is presented.

As a first step, Query 810 is made. If the downstroke speed value D is equal to the detected minimum speed value Y (such as when the 30 second minimum speed timer has expired, then a subsequent query is presented at Query 815. The controller 400 asks if the present speed value V is greater than 120% (or some selected percentage over 100%) of the minimum speed value Y. If so, then the swap relay is energized as shown at Box 870. Energizing the swap relay means that a replacement speed signal is being generated. The controller 400 returns to Line 55 in FIG. 5A.

It is noted here that the Swap Relay is de-energizing between Boxes 580 and 585. The Swap Relay gets energized in Box 870 following the conclusion of an MSE, or upon the initial start-up where it learns the values of X (pre-set upstroke speed) and Y (pre-set downstroke speed). The Swap Relay 870 gets de-energized upon the start of every MSE event, which happens when the MSE timer expires in Box 575.

If the present speed value V is not greater than 120% (or the selected percentage over 100%) of the pre-set minimum speed value Y, then the controller 400 returns to the speed detection module Start at Box 805. This is indicated at Box 820. It is noted here that value Y is the controller 400 value for “Minimum Working Speed.” Value Y may be converted to Hertz by dividing by the 45.5 ratio, wherein a value of 45.5 is equivalent to 1 Hertz.

Returning to Query 810, if the downstroke speed value D is not equal to the minimum speed value Y, then a new query is presented. In Query 825, the controller 400 asks if the present speed value V is greater than or equal to a pre-set maximum speed value X. Value X is the controller 400 value for “Maximum Working Speed.” Value X is converted to Hertz by dividing by a 45.5 ratio. This value X may be adjusted upward but never downward.

If the present speed value V is greater than or equal to the maximum working speed X, then the maximum working speed X is set to the present speed value V. This is seen at Box 830. In addition, an upstroke speed value U is set at the present speed value V. Value U is the value of the upstroke voltage speed signal V sent from the controller 400 to the Toshiba Drive 140. This is shown at Box 835. The controller 400 then returns to Box 805, as indicated at Box 840.

If the present speed value V is not greater than or equal to the Maximum Working Speed X, then the controller 400 moves to a separate Query 845. Query 845 asks if the present speed value V is less than ¼ (or some low fraction) of the maximum working speed X. If the answer is “No,” then the pump must be on its upstroke. Controller 400 again returns to the original Start at Box 505 via Line 55 as shown at Box 840. However, if the present speed value V is less than ¼ (or some designated low fraction) of the maximum working speed X, then the pump must be on its downstroke and a series of new settings is made.

First, the minimum working speed Y is set to the present speed value V. This is shown at Box 850. Next, the speed output value is set to the upstroke value U minus the downstroke speed drop value Z. This is provided at Box 855. Value Z is the desired difference between the upstroke U and downstroke D pumping speeds. The default is 24 Hertz, but jumper wires in digital input 2 and/or 3 can change these values to, for example, 27, 30, or 33 Hertz. Thus, a wire jumper may be used as opposed to a programming change. As shipped, there is a jumper wire in Input 3, for a 30 Hertz speed reduction. Moving the jumper to input 2 will drop this to 27 Hertz, and removing the jumper completely will drop Z to 24 Hertz. Jumpering both inputs 2 and 3 will result in a 33 hertz speed drop. Keep in mind that in the preferred embodiment, the downstroke pumping speed D will never drop below the minimum working speed Y.

In one example, the rod pumping controller 250 is pre-set to have a maximum pumping speed X of 60 Hertz, and a minimum pumping speed Y of 10. The pump stroke controller 400 is activated for a period of at least 24 hours for the purpose of taking samples of the voltage signals V being generated by the rod pumping controller 250. Over a period of time, referred to herein as a start-up time, the controller 400 ascertains an average pumping signal Ap of, for example 15, or 20, or 25. A lower average is suggestive of a lower pump fillage and more frequent instances where the rod pump controller is dropping the pump speed down to its minimum pumping speed Y.

Operation of the controller 400 will also tell the petroleum engineer or the operator what the pre-set values of X and Y are. In this respect, the controller 400 can infer X and Y by simply observing maximum X and minimum Y working speeds during the startup time. This informs the operator or the petroleum engineer what the spread is. In the example where X is 60 and Y is 10, the initial spread is 50 Hertz. The operator may choose to reduce this spread down to 35 Hertz by setting value Z at this value.

Based on this data, the petroleum engineer or the operator may also set a value B. This represents a desired number of minimum speed events (MSE's). As discussed below in connection with FIG. 9 and the speed adjustment module 900, the actual number of MSE's over a set period of time is compared to the desired number of MSE's as part of an equation for making maximum working speed adjustments.

Referring again FIG. 8, the value K is set at this time value for purposes of accumulating the running sum of K values as used to determine average Hertz. This is indicated at Box 860. Finally, a new minimum working speed Y and maximum working speed X are displayed. Display may be on a wellsite display screen or LCD 465; alternatively or in addition, display may be on a web page. The swap relay is then energized as shown at Box 870. The controller 400 returns to start 505 as again given at Box 875. In one expression, the flow chart 500 has now told the controller 400 that it is reading upstrokes and downstrokes, and the controller 400 should “take over” pump speed commands.

Returning to FIGS. 5A and 5B, if the Swap Relay is energized in Box 565, a query similar to Query 815 is made. In Query 570, the controller 400 asks whether the present speed value V is greater than 120% (or some selected percentage over 100%) of the minimum speed value Y. This is how the flow chart 500 determines whether the pump is on its upstroke. If the voltage signal V is greater than the minimum speed Y, then the pump is on its upstroke. If so, then the controller 400 goes through the upstroke module 600. This is shown at Box 600, and also in FIG. 6.

Processing steps for the upstroke module 600 are presented in detail, in one embodiment, in FIG. 6. The upstroke module 600 is used to calculate and set the upstroke speed U. As can be seen in FIG. 6, the upstroke module 600 has a representative Start, shown at Box 605. This means that a voltage value V is presented.

Query 610 is shown. If the present speed value V is greater than the maximum working speed X, then the maximum working speed X is increased to equal the present speed value V. This is provided at Box 615. This means that a new maximum working speed X is learned. In addition, the display (such as a web page user interface) is revised to show the new maximum working speed X. This is shown at Box 620.

The controller 400 then moves to a next query 625. At the same time, if the present speed value V from Start 605 is not greater than the maximum speed value X, then the controller 400 moves to Query 625. Query 625 asks if the present speed value V is less than the minimum working speed Y plus the adjustment value A. Value A is the adjustment value given to the actuator, e.g., a variable frequency drive motor 140, every six hours. This adjusts a speed of the upstroke U based on an averaging of pump speed data collected over a multiple hour period to provide a more optimum pump speed.

If the answer is “Yes,” then the upstroke speed value U is changed to be equal to the minimum working speed Y. This is shown at Box 630. This keeps the controller from slowing the upstroke speed U below the minimum working speed Y. If the answer is “No,” then the upstroke speed value U is set to be equal to the present value V less the adjustment value Av. This is given in Box 635. Optionally, adjustment value Av may be modified to value H as discussed further below.

In either instance, the controller 400 next establishes a series of settings. The speed output value is set to be equal to the upstroke speed value U, which is [V−Av]. This is provided at Box 640. In addition, the present voltage value of K is set to be equal to the upstroke speed value U. This is seen at Box 645. The minimum timer is then reset, as shown at Box 650.

While the timer is running, the controller 400 will monitor voltage for, for example, 30 seconds. If the controller 400 sees the drive running continuously at a minimum working speed, e.g., 10 Hertz, then it knows pump fillage is below the set point. The controller 400 turns off the Swap Relay (or “unplugs the equation”) and waits to receive a speed signal. Incidentally, if the speed remains at minimum working speed Y for the full 30 seconds, this is counted as a minimum speed event MSE.

A new Query 655 is next optionally presented. The controller 400 asks if the present speed value V is greater than 90% (or some selected amount just under 100%) of the maximum working speed X. If the answer is “Yes” over a period of, say, 5 minutes, and W stays equal to 1, this indicates that there really was fluid in the wellbore and the MSE was a true minimum speed event. Stated another way, unless W has been set to “1” for 5 minutes, the controller 400 will not count this as a MSE. The controller 400 moves to the downstroke module 700 via Line 60.

If the answer is “No,” then the controller 400 moves directly to the downstroke module 700 via Line 60 without setting value W to 1. Return Box 665 indicates movement of the signal on to the downstroke module 700 in accordance with FIG. 5B.

The flow chart 500 may also direct the signal to the downstroke module 700 if the answer to Query 570 is “No.” In that instance, the controller 400 knows that the pump is on its downstroke.

Processing steps for the downstroke module 700 are presented in detail, in one embodiment, in FIG. 7. The purpose of the downstroke module 700 is to determine pump speed D on the downstroke. More specifically, the controller 400 makes sure that pumping speed does not try to run below minimum working speed Y on the downstroke. As can be seen in FIG. 7, the downstroke module 700 has a representative Start, shown at Box 705. This means that a voltage value representing the upstroke speed value U is given.

In one aspect, to get an initial downstroke speed value D, the controller will subtract a pre-selected drop value Z such as 30 Hertz from the upstroke speed U. However, the downstroke speed value (after applying Z) cannot fall below the minimum speed value Y.

Query 710 is first presented. The controller 400 asks if the upstroke speed value U is greater than the minimum working speed Y (plus the downstroke speed value drop Z). If the answer is “No,” then the downstroke speed value D is established as the minimum working speed Y. This is shown at Box 715. If, on the other hand, the answer is “Yes,” then the downstroke speed value D is set to be equal to the upstroke speed value U (less the downstroke speed drop value Z). This is shown at Box 720.

Value D is the downstroke voltage speed signal sent from the controller 400 to the Toshiba Drive 140. To arrive at Hertz, one divides the variable value D by 45.5. The controller 400 will output a DC speed signal of 0 to 10 volts, with the Toshiba drive 140 assigning 90 Hertz to 10 volts, 45 Hertz to 5 volts, etc. In the controller 400, 10 volts corresponds to a program value of 4,096. Hence, the value of 45.5 is obtained by dividing 4,096 by 90. Alternatively, speed signals may be communicated over serial ports using a serial communications protocol such as Modbus.

Referring again to FIG. 7, the speed output value is set to be equal to the downstroke speed value D. This is seen at Box 725. The present voltage value K in turn, is set to be equal to the downstroke speed value D, shown at Box 730, while the signal returns to Line 70 of FIG. 5B as indicated at Box 740.

At this point in FIG. 5B, the upstroke speed U and the downstroke speed D have been set. Query 575 then asks if the minimum speed timer exceeds 30 seconds (or some selected period of time). If the answer is “No,” this indicates that there is pump fillage and the pump speed is increasing above the minimum working speed Y. The controller 400 returns the signal back to the original Start Box 505 and the averaging routine of flow chart 500 begins again. If the answer is “Yes,” this indicates a minimum speed event. The controller 400 moves to Query 580 and asks if the value of W from the upstroke module 600 is equal to 1. (The W value must be “1” for the MSE to be counted or it will be discounted as a false MSE.) If the answer is “No,” the signal then moves back to Box 530 via Line 80 and the controller 400 is turned off. If the answer is “Yes,” the controller 400 increases a minimum speed event value E by 1 as shown in Box 590, de-energizes the Swap Relay as shown in Box 590, and resets W to zero as provided in Box 595. Note that the controller 400 will likely, during operation, energize and de-energize the swap relay many times each day. Each time an MSE is counted, the W value is reset to zero.

In the current invention, the minimum speed event may be referred to as “MSE.” An MSE occurs when the rod pump controller 250 has encountered consistently low pump fillage, and has reduced both the upstroke and downstroke to a minimum working speed. Low pump fillage is typically encountered when the well is pumping too fast and the reservoir cannot replenish the wellbore fast enough. Low pump fillage may also happen as a result of slug flow behavior.

Based on well history, an operator can determine an ideal number of MSE's for the well. Value B is assigned as a desired number of MSE's. In one embodiment, the units for B are the desired number of MSE's per 6 hour period. If a well has a tendency to slug every two hours, a good initial B value would be 2 or 3.

Similar to value B, value E is the number of actual minimum speed events measured by the controller 400 over the same six hour period. As currently configured, the controller 400 compares the actual MSE's E to the desired MSE's B four times each day. This is every six hours, as shown in Query 545.

Following a MSE, W is set to zero. When the upstroke speed signal from the controller 250 subsequently reaches the maximum working speed,” it will advance to 1 and allow another MSE to be recorded. This keeps false MSE's from being recorded should pump fillages appear high due to high pump slippage.

Returning back to FIG. 5A, and as noted above, if one of the four designated times for making a speed adjustment is detected in connection with Query 545, then a speed adjustment is made using the speed adjustment module. A speed adjustment module, in one embodiment, is presented at 900 in FIG. 9.

FIG. 9 is a flow chart presenting steps for iteratively adjusting pump speed. This is where the periodic (e.g., six-hour) speed calculations are made. A Start is presented at Box 905. Here, the average speed value Av as determined at one of the four designated times provided in Query 545 is presented. (This average is also shown at Box 930, expressed as K divided by Q.) In Box 910, the speed adjustment module 900 saves the number of MSE's E over the previous six hour period. Then, in Box 920, the controller 400 calculates the difference between E and B. Once the difference between actual E and desired B MSE's has been determined, the difference is multiplied by value F, which represents a pre-selected “Gain” or magnitude of the speed adjustments made by the controller 400. A low F value results in little change, as 1 Hertz is 45.5 units.

Value H is a value optionally added to adjustment value Av four times a day. Value H is calculated from the difference between actual MSE's E minus desired MSE's B over the last six hours times the gain F., with gain F being an arbitrary value that increases pump speed, such as 105%. (E−B)×F=H . This value can be positive or negative.

In Box 930, K and Q are reset to zero. From there, value Av may be changed by the controller 400. This is shown at Query 940 and Box 950.

Referring to Query 940, the controller 400 asks if the value T is greater than a certain percentage. T is a pre-selected percentage set point by which the average Hertz will be multiplied to get the desired average Hertz. For example, 105 will be 105% of actual calculated Hertz. If the answer is “Yes,” then the speed adjustment module 900 moves to Box 950. Here, the controller 400 iteratively solves for a new pump control signal (or adjustment value Av) that will result in the same 6 hour average Hertz speed as the current speed value T/100. Stated another way, if the value of T is above 100, then the average speed determination will override the MSE algorithm. If the answer is “No,”, then the step of Box 950 is skipped.

The new pump control signal (or adjustment value Av) is saved, as shown in Box 960. The controller 400 then returns to FIG. 5A at Line 90, as shown at Box 970 of FIG. 9. At this point, the maximum speed X minus Av is equal to U. Note that the adjustment value H is not used here as we are using the average speed algorithm.

Certain other variables may be included, but are not shown in the flow charts. Variable J may be used in a programming loop to save 600 values of E (actual MSE's) and X−Av (adjusted Maximum Working Speed). These values are calculated every six hours, with a running 75 days of these values being saved. The six most recent values of X−Av are shown at the bottom of the web page.

The pump stroke controller 400 is designed to improve the operation of most any available rod pump controller 250. The pump stroke controller 400 creates an improved pumping system for a reciprocating rod pump that tunes the pumping unit speed to match the average in-flow of production fluids over a multiple hour period (at least one hour and preferably six to eight hours), thereby providing an ideal speed. The controller 400 will not over-react to high pump fillage caused by a slug of fluid being pushed from a horizontal leg by an expanding gas “piston,” and unnecessarily cause speed increases. Conversely, when the low-density fluid slug has passed and the lateral is “blowing down,” the pump speed controller 400 will not change any speed settings. Yes, the pump-off controller 250 will try to reduce the pumping speed temporarily to the operator set minimum working speed, but the pump stroke controller 400 will intervene and maintain pump speeds in accordance with “tuned” U and D values. In addition, the controller 400 will tune the frequency of these events E to be in line with the historical slug behavior of the well.

Pumping too fast will cause excessive cycling between minimum and maximum speeds, when the goal should be to have the cycling correspond to the horizontal well's natural behavior. As designed, the pump stroke controller 400 disclosed herein will make changes to the maximum upstroke speed X four times per day, not each stroke (which would be 7,000 plus times per day).

The pump stroke controller 400 can also take advantage of pumping equipment that is oversized for a given well. Unlike pump-off controllers 250 that slow motor speeds by a fixed number of Hertz, the pump stroke controller 400 will keep the upstroke pumping speed U between 24 and 33 Hertz higher than the downstroke pumping speed D (as set by the operator). When less strokes per day are needed, both the upstroke U and the downstroke D speeds will drop by the same amount. There will always be a difference of 24 to 33 Hertz (as minimum working speed Y will allow), unless the downstroke speed reduction reduces the pump capacity below that needed to produce all well fluids.

In a preferred embodiment, and as described above, the pump stroke controller 400 will provide for a lower pump speed on the downstroke (speed D) than on the upstroke (speed U). Preferably, the entire downstroke is slowed. Several benefits arise from running the pumping unit slower on the downstroke, the most significant of which is decreased pump slippage due to less time spent by the pump in the upstroke. Those of ordinary skill in the art will understand that pump slippage occurs when the travelling valve ball is on the seat, which is essentially during the upstroke. When pump fillage is below 100%, there is admittedly a brief period of the downstroke where slippage still occurs. However, slippage is actually desirable at this point, as it results in the travelling valve opening sooner. Due to a closed standing valve, downstroke slippage does not result in less fluid entering the pump or less fluid production at the surface, unlike upstroke slippage that occurs as fluid is simultaneously entering the pump through the standing valve.

Conventional pumping units spend about 50% of their stroke duration on the upstroke. Reverse geometry pumping units spend about 55% of their stroke duration on the upstroke. Interestingly, for the same strokes-per-minute speed, reverse geometry pumping units will have about 10% more slippage than conventional pumping units.

Instead of the upstroke consuming 50% to 55% of the stroke duration as is the industry norm, it is proposed herein to take advantage of the variable frequency drive (VFD) motor to slow the pump speed on the downstroke so that the downstroke consumes the majority of the stroke duration. For example, the downstroke may consume greater than 60% of the total stroke duration or, more preferably, greater than 75% of the total stroke duration. The resulting upstroke duration can be as low as 8% of the total stroke duration. Since pumps primarily slip on the upstroke, actions taken to reduce the duration of the upstroke (and reciprocally increase the duration of the downstroke) will proportionally reduce slippage. This allows for worn pumps to last longer, or new pumps to be designed with higher slippage tolerances.

In one aspect, the downstroke is 4 strokes per minute (SPM) slower than the upstroke, regardless of the upstroke speed. This is the value of Z. For example, the pump may run at 6 SPM on the upstroke and 2 SPM on the downstroke. This averages 3 SPM. In this arrangement, the upstroke takes 5 seconds and the downstroke takes 15 seconds, so the downstroke consumes 75% of a 20 second stroke duration. Beneficially, a 4 SPM differential between the upstroke speed and the downstroke speed reduces the load placed on the gearbox as well as the “electric brake” resistor.

In another aspect, the upstroke runs at 12 SPM while the downstroke runs at 8 SPM. This is also a 4 SPM reduction; however, the stroke speed here averages only 9.6 SPM. In this case, the upstroke duration is 2.5 seconds and the downstroke duration is 3.75 seconds, totaling 6.25 seconds. This puts the downstroke at 60% of the total stroke duration. There are, of course, unlimited variations for values U and Z; what is offered here are just examples.

Another advantage to reducing the downstroke speed is that a slower downstroke provides greater time for evolving gas to escape the gas anchor. This provides greater pumping efficiency.

It is also observed, that higher “Minimum Rod Loading” results from slowing the downstroke. Minimum loads increasing are predicted by design software and repeatedly confirmed by dynamometer data, resulting in a desirable increased Min/Max PRL value. Higher minimum loads allow higher maximum loads per the Goodman Diagram, should the operator desire to take advantage of this in their rod/pump design. Rod buckling can occur despite the best design mitigation features. High minimum loads will reduce the compression forces that cause this buckling. Pumps tagging bottom will tag much softer due to the much slower plunger velocity.

It is preferred that the pump stroke controller 400 be controllable through a web-based platform. A custom 0.HTM webpage is loaded over Ethernet into each pump stroke controller 400 using, for example, a Filezilla™ program. By installing this custom webpage, it allows several pump stroke controllers 400 to be tested simultaneously, with results observed over a network. One PC can scroll through various browser pages to confirm proper actions are taking place. This same webpage can assist field personnel in making set point changes, should they be needed.

After successful testing, the well name and specific IP address (if provided by the customer), will be loaded into the pump stroke controller 400. The PLC will reboot after this address is saved, making it no longer accessible via the assembly/testing Ethernet LAN. The temporary 12 VDC power and simulated inputs and outputs are then removed, and the pump stroke controller 400 is packaged in a well labelled shipping container for delivery to the specified well. Included in the shipping box are two switches and labels.

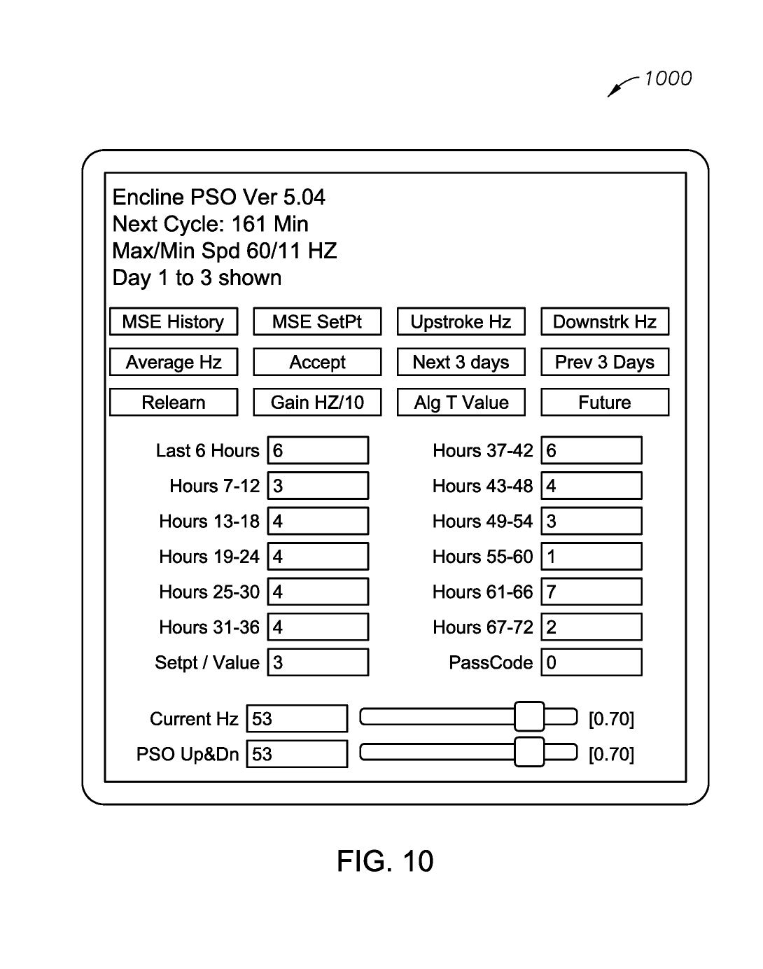

The pump stroke controller 400 may optionally feature a webpage that will allow various pieces of data to be displayed, as well as the adjustment of certain pieces of data. FIG. 10 is an illustrative screen shot showing operating conditions of the pump stroke controller 400 through a web interface. This webpage is titled 0.HTM in the PLC, and is easily accessible once an IP address is given to the PLC. The website is accessible through the operator's internet connection. Access to the PLC for changing programs, or online monitoring, is also possible via this internet IP address. This same webpage allows users to modify the control settings remotely, thereby conserving resources.

In FIG. 10, each of the gray shaded buttons will change the referenced program variable as indicated by the button. The button must be clicked twice, once to engage, and once to disengage. These buttons can be used to access up to 150 days of historical data on actual and desired MSE count, average Hertz, maximum upstroke speed [X−Av], and maximum downstroke [(X−Av)−Z] speeds, and will be shown in the blue highlighted fields. Regarding the display with the yellow background, real-time values for present time, MSE count, and minutes until the next 6 hour calculation period show in the second line, the maximum X and the minimum Y working speeds on the third line, and the average Hertz Av for the previous 6 hours on the fourth line. The current real-time Hertz output going to the Toshiba Global drive is shown where it is labelled “Current HZ”.

Based on the above description of pump speed controller 400, a method for optimizing speed of a pump for a well is also provided herein. The method first includes identifying a well that is experiencing slug flow. In this method, the identified well will have a pumping system comprising a downhole pump. The downhole pump resides within a wellbore that is associated with the well. The pumping system also includes a rod string extending down into the wellbore and mechanically connected to the pump, and an actuator configured to reciprocate the rod string and connected downhole pump as down strokes and up strokes. Finally, the pumping system includes a pump-off controller 250 at the well site configured to receive electrical signals indicative of pump fillage for the pump. More specifically, signals are received from a load cell which converts load readings to voltage.

The pump-off controller 250 knows how much the rods weigh, how much the pump weighs, and how much the system will weigh when the pump is filled with production fluids. In another aspect, the pump-off controller 250 receives signals showing amperage of the motor. In either aspect, the pump-off controller 250 is designed to deliver first control signals V to the actuator to change pump speed in order to maintain pump fillage at a desired set point every stroke.

The method also includes intercepting the first signals V. The method then includes processing the first signals V to tune the pump speed to reflect the average in-flow over a period of time that is at least one hour. In this way, a second signal Av instructing the actuator to generate a more ideal pump speed, or “tuned” pump speed, is generated.

In one aspect, processing the first signal V comprises subtracting value Av from the maximum working speed X every six hours, and using this new differential as the upstroke speed U. For example, a voltage value may be reduced by one volt. This, in turn, reduces pump speed. Downstroke speed D is reduced in a corresponding manner by subtracting a pre-set drop-down value Z (such as 24 Hertz) from U to provide D. Reducing downstroke speed D minimizes gas interference. In one example, the upstroke speed runs at 12 SPM, while the downstroke speed runs at 8 SPM.

In one aspect, processing the first signals V further comprises monitoring Minimum Speed Events (MSE) E over a multi-hour period. A value H is computed as set out above, with H then being subtracted from Av as the adjustment value. Thus a new adjustment speed for the upstroke U would be: U=[(X−Av)−H]. A new adjustment speed for the downstroke D would then be the greater of (i) the minimum working speed Y, or (ii) [U−Z].

In an alternate arrangement, if too many MSE's E occur over, for example, a six hour period, then a portion of the second signal value Av is again subtracted, thereby again reducing pumping speed. Pump speed may be reduced, for example, from 10 strokes/minute to 5 strokes/minute, but only once over a multi-hour (no more than once/hour) time period. This helps keep the well from being “over-pumped.”

The method provides the well operator with peak production while reducing maintenance and overall operating costs. The method limits excessive pumping speeds caused by slugging tendencies of the well, which otherwise fools a pump-off controller into incorrectly making multiple large pump speed adjustments. The method has particular application to horizontally-completed wells where slug flow regimes frequently occur.

Further, variations of the method for optimizing pump speed may fall within the spirit of the claims, below. It will be appreciated that the inventions are susceptible to modification, variation and change without departing from the spirit thereof.

I claim:

1. An oil well pumping system, comprising:
a downhole pump residing within a wellbore;
a rod string extending down into the wellbore and mechanically connected to the pump;
a wellhead having an actuator configured to reciprocate the rod string and connected downhole pump as down strokes and up strokes; and
a pump stroke controller configured to adjust a speed of the upstroke (U), a speed of the downstroke (D), or both, in response to receiving signals (V) indicative of pump fillage, wherein the pump stroke controller tunes the pump speeds (U) and (D) based on an averaging of pump speed data collected over a multiple hour period to provide optimum upstroke (U) and downstroke (D) speeds.

2. The oil well pumping system of claim 1, wherein the wellbore is completed in a substantially vertical orientation.

3. The oil well pumping system of claim 1, wherein the wellbore is completed to have a deviated section.

4. The oil well pumping system of claim 3, wherein the deviated section is substantially horizontal.

5. The oil well pumping system of claim 1, wherein the downhole pump is a downhole sucker rod pump.

6. The oil well pumping system of claim 5, wherein the actuator is a hydraulic pumping system having an elongated piston positioned vertically over a wellhead, operatively connected to the rod string.

7. The oil well pumping system of claim 5, wherein the actuator comprises:
an electric motor or a combustion engine as a prime mover configured to turn a drive shaft; and
a walking beam that pivots about a fulcrum and is operatively connected to the rod string, wherein cyclical pivoting of the walking beam reciprocates the rod string and connected downhole pump.

8. The oil well pumping system of claim 7, wherein:
the rod string is mechanically connected to the piston through a polish rod; and
the pump stroke controller is configured to correlate pump speed in Hertz to volts.

9. The oil well pumping system of claim 1, further comprising:
a rod pumping control unit configured to receive the signals indicative of pump fillage, and generate the signals (V) as first control signals on each stroke to adjust upstroke speed, downstroke speed, or both; and
wherein:
the pump stroke controller is separate from the rod pumping control unit or is integral to a circuit board of the rod pumping control unit; and
the pump stroke controller is configured to intercept the first control signals (V), and process the first control signals (V) to generate an average value (Av) at pre-set times each day.

10. The oil well pumping system of claim 9, wherein:
the rod pumping control unit comprises a programmable logic controller that has pre-set values of maximum working speed (X) and minimum working speed (Y); and
the pump stroke controller tunes pump speeds by producing an upstroke speed (U) equal to the maximum working speed (X) less the average value (Av), at the pre-set times each day.

11. The oil well pumping system of claim 10, wherein the pump stroke controller is further configured to reduce the downstroke speed (D) so that the downstroke speed (D) consumes greater than 60% of a pump cycle time.

12. The oil well pumping system of claim 10, wherein:
the pump stroke controller tunes the pumping speed by sending speed signals for (U) and (D) to an electric drive motor as the actuator;
the optimum pump speeds comprise an increased upstroke speed signal, a decreased downstroke speed signal, or both; and
the speed signals are communicated (i) over serial ports using a serial communications protocol using analog voltage or current signals, or (ii) over an Ethernet connection.

13. The oil well pumping system of claim 10, wherein:
the pump stroke controller counts a frequency of Minimum Speed Events (MSE) indicative of poor pump fillage, and further tunes the pumping speed to provide the optimum pump speeds by utilizing an adjustment value (H) to incrementally adjust the upstroke pump speed (U), wherein:
(U)=[(X)−(Av)]−(H).

14. The oil well pumping system of claim 13, wherein the pump stroke controller is configured to calculate value (H) by:
determining an actual number (E) of MSE's;
receiving an input for the desired number (B) of MSE's;
comparing the value (E) to value (B) a set number of times each day;
calculating a difference between (E) and (B);
multiplying the difference by a pre-set Gain variable (F) to reach the value (H), wherein:
H=(E−B)×F.

15. The oil well pumping system of claim 14, wherein the programmable logic controller also has pre-set values for a desired number (B) of Minimum Speed Events (MSE), defined as an event where both the upstroke speed (U) and downstroke speed (D) have been reduced to the pre-set minimum working speed (Y) in response to consistently low pump fillage.

16. The oil well pumping system of claim 15, wherein determining an actual number (E) of MSE's comprises:
identifying instances where the first control signals (V) run at a minimum speed for at least 30 seconds; and
summing those instances within the multiple hour period.

17. The oil well pumping system of claim 12, wherein:
the pump stroke controller is configured to set the downstroke pump speed (D) as the greater of (i) the minimum working speed (Y), or (ii) [U−Z]; and
Z is a pre-set drop-down value.

18. The oil well pumping system of claim 17, wherein:
the pre-set number of times is four to eight; and
average value (Av) is calculated at pre-selected times each day according to the pre-set number of times.

19. A method for optimizing stroke speed of a pump for a well, comprising:
identifying a well having a deviated or horizontally completed portion, and the well having:
a downhole pump residing within a wellbore and associated with the well,
a rod string extending down into the wellbore and mechanically connected to the pump,
an actuator at a wellhead over the wellbore configured to reciprocate the rod string and connected downhole pump as upstrokes and downstrokes, and
a pump-off controller configured to receive electrical signals indicative of pump fillage for the pump, and deliver first signals (V) to the actuator to change pump speed in order to maintain pump fillage at a desired set point;
intercepting the first signals (V) using a pump stroke controller;
processing the first signals (V) to identify a maximum working speed (X) and a minimum working speed (Y) associated with the pump-off controller;
further processing the first signals (V) to determine an average value (Av) of the first signals (V) over selected times each day, and using value (Av) to send a signal to the actuator at pre-selected times each day to change pump speed to maintain a more optimum pump fillage.

20. The method of claim 19, wherein changing pump speed comprises:
calculating a new upstroke speed at the pre-selected times each day based upon:
(U)=(X)−(Av).

21. The method of claim 20, wherein intercepting first signals (V) comprises:
(i) removing an analog output wire from the pump-off controller, and connecting the output wire to an input bus in the pump stroke controller; or
(ii) viewing values (V) delivered from the pump-off controller to a processor through a first Ethernet connection, and re-routing the values (V) to the pump stroke controller through a second Ethernet connection.

22. The method of claim 20, further comprising:
adjusting value (U) at the pre-selected times each day by further applying value (H) to reduce pump speed on the upstroke, wherein value (H) is calculated by:
determining an actual number (E) of MSE's;
receiving an input for the desired number (B) of MSE's;
comparing the value (E) to value (B) a set number of times each day;
calculating a difference between (E) and (B);
multiplying the difference by a pre-set Gain variable (F) to reach the value (H),
wherein:
H=(E−B)×F; and
setting the upstroke pump speed (U) as [(X)−(Av)]−(H).

23. The method of claim 21, wherein changing pump speed further comprises:
calculating a new downstroke speed (D) at the pre-selected times each day, wherein the downstroke speed (D) of each pump cycle is set to be the greater of (i) the minimum working speed (Y), or (ii) (U) minus a pre-set drop-down value (Z).

24. The method of claim 23, wherein the pump-off controller is separate from the pump stroke controller at the wellhead, or the pump stroke controller is integral to a circuit board of the pump-off controller, and is configured to correlate pump speed in Hertz to volts.

25. A method for optimizing stroke speed of a pump for a well, comprising:
identifying a well wherein gas slugging is taking place, the well having:
a well head,
a downhole pump residing within a wellbore and associated with the well,
a rod string extending down into the wellbore and mechanically connected to the pump,
an actuator at the well head configured to reciprocate the rod string and connected downhole pump as upstrokes and downstrokes, and
a pump-off controller configured to receive electrical signals indicative of pump fillage for the pump, and deliver first signals (V) to the actuator to change pump speed each cycle in order to maintain pump fillage at a desired set point;
intercepting the first signals (V) using a pump stroke controller at the well head;
processing the first signals (V) to tune the pump speed at selected times each day to reflect the average in-flow of fluids into the pump over a period of time that is at least one hour; and
in response to the processing, using average signals (Av) to instruct the actuator to change the pump speed as a tuned pump speed at selected times to maintain a more optimum pump fillage.

26. The method of claim 25, wherein:
the tuned pump speed comprises a modified upstroke speed (U), a modified downstroke speed (D), or both;
the period of time is every two to eight hours; and
the selected times occur every four to eight hours.

27. The method of claim 25, wherein the well is completed to have a substantially horizontal portion.

28. The method of claim 26, wherein changing the pump speed comprises:
reducing the downstroke speed (D) of the pump so that the downstroke speed (D) consumes greater than 60% of a pump cycle time;
increasing an upstroke speed of the pump and decreasing a downstroke speed of the pump; or
both.

29. The method of claim 26, wherein changing the pump speed comprises:
calculating a new upstroke speed at the pre-selected times each day based upon:
(U)=(X)−(Av).

30. The method of claim 29, further comprising:
adjusting value (U) at the selected times each day by further applying value (H) to reduce pump speed on the upstroke (U), wherein value (H) is calculated by:
determining an actual number (E) of MSE's;
receiving an input for the desired number (B) of MSE's;
comparing the value (E) to value (B) a set number of times each day;
calculating a difference between (E) and (B); and
multiplying the difference by a pre-set Gain variable (F) to reach the value (H), wherein:
H=(E−B)×F;
so that (U)=[(X)−(Av)]−(H).

31. The method of claim 30, wherein changing pump speed further comprises:
calculating a new downstroke speed (D) at the pre-selected times each day, wherein the downstroke speed (D) of each pump cycle is set to be the greater of (i) the minimum working speed (Y), or (ii) (U) minus a pre-set drop-down value (Z).

32. The method of claim 30, wherein:
value (B) is set by manually holding a set-switch at the wellhead for a period of time that corresponds to the desired (B) value; and
value (F) is set by placing a jumper wire onto a selected input bus at the well head.

33. The method of claim 32, wherein (Z) is between 20 and 33 Hertz.

34. The method of claim 26, wherein intercepting the first signals (V) comprises:
(i) removing an analog output wire from the rod pumping control unit, and connecting the output wire to an input bus in the pump stroke controller; or
(ii) removing a ModBus Ethernet connection from the rod pumping control unit and re-routing the first control signal (V) delivered through a ModBus Ethernet connection.

35. The method of claim 26, further comprising:
checking the first signals (V) for stability.

36. The method of claim 35, wherein checking the first signal for stability comprises receiving multiple first signals (V), and selecting a signal as a stable signal that represents at least two consecutive voltage outputs of the pump-off controller that are substantially identical.

37. A method for optimizing stroke speed of a pump for a well, comprising:
identifying a well having:
a downhole pump residing within a wellbore and associated with the well,
a rod string extending down into the wellbore and mechanically connected to the pump,
an actuator configured to reciprocate the rod string and connected downhole pump as upstrokes and downstrokes, and
a pump-off controller configured to receive electrical signals indicative of pump fillage for the pump, and deliver first signals (V) to the actuator to change pump speed at each cycle in order to maintain pump fillage at a desired set point;
intercepting the first signals (V) by removing an analog output wire from the pump-off controller, and connecting the output wire to an input bus in a pump stroke controller at the well;
processing the first signals (V) to identify a frequency (E) of Minimum Speed Events (MSE's), each (MSE) being indicative of low pump fillage; and
further processing the first signals (V) to determine average first signal values (Av) over a selected period of time that exceeds one hour as an average pumping speed, and using the average pumping speed (Av) to provide tuned upstroke (U) and downstroke (D) control signals at selected time periods each day.

38. The method of claim 37, wherein the well is completed to have a substantially horizontal portion.

39. The method of claim 37, wherein:
the selected period of time is every two to eight hours; and
the tuned pump speed is sent to the actuator every four to eight hours.

40. The method of claim 39, wherein providing tuned upstroke and downstroke control signals comprises:
calculating a new upstroke speed at the pre-selected times each day based upon:
(U)=(X)−(Av); and
calculating a new downstroke speed at the pre-selected times each day based upon the greater of a minimum running speed (Y) of the pump-off controller, or (D)=−(U)−(Z), wherein (Z) is a pre-set drop-down value.

41. The method of claim 40, further comprising:
adjusting upstroke value (U) by applying value (H) to reduce pump speed on the upstroke (U), wherein value (H) is calculated by:
inputting a desired number (B) of Minimum Speed Events (MSE);
comparing the value (E) to value (B);
multiplying the difference between (E) and (B) by a pre-set Gain variable (F) to reach value (H), wherein: H=(E−B)×F; and
so that (U)=[(X)−(Av)]−(H).

42. The method of claim 41, wherein:
value (F) is set by placing a jumper wire onto a selected input bus at the wellhead;
value (B) is set by manually holding a set-switch at the well head for a period of time that corresponds to the desired (B) value; and
the value (B) is between 2 and 5 MSE's per day.

43. The method of claim 42, wherein (Z) is between 20 and 33 Hertz.

44. The method of claim 43, further comprising:
allowing the pump-off controller to run for a startup time of least 24 hours before making any speed adjustments;
calculating an average pumping speed (Ap) over the at least 24 hours;
inferring a pre-set maximum working speed (X) of the pump-off controller by observing maximum stroke speeds during the startup time;
inferring a pre-set minimum working speed (Y) of the pump-off controller by observing minimum stroke speeds during the startup time;
inferring value (B) based on value (X), value (Y), or both based at least in part on Ap.

45. A method of operating a well, comprising:
providing a fluid pumping system for the well for the production of hydrocarbon fluids from a wellbore associated with the well, wherein the pumping system comprises:
a downhole pump residing within the wellbore;
a rod string extending down into the wellbore and mechanically connected to the pump;
an actuator configured to reciprocate the rod string and connected downhole pump as upstrokes and downstrokes;
a rod pumping control unit configured to generate first pumping speed control signals (V) indicative of pump fillage; and
a pump stroke controller that is separate from the rod pumping control unit configured to intercept the control signals (V);
using the rod pumping control unit, generating the first control signals (V);
using the pump stroke controller, in response to signals (V), generating second control signals (Av) representing an average in-flow of fluids into the pump over a period of time that is at least one hour; and
adjusting an upstroke speed (U) and a downstroke speed (D) based on the second control signals (Av) at each of a pre-selected time each day to maintain pump fillage at a desired set point.

46. The method of claim 45, wherein:
the well is completed to have a substantially horizontal portion; and
the method further comprises determining that the well is subject to slug flow.

47. The method of claim 45, wherein adjusting the speed (U) of the upstroke, the speed (D) of the downstroke, or both, comprises reducing the speed of the downstroke so that the downstroke speed consumes greater than 60% of a pump cycle time.

48. The method of claim 45, wherein:
the period of time is every six to eight hours; and
the downstroke speed of the pump is 3 to 5 SPM slower than the upstroke speed.

49. The method of claim 48, wherein intercepting the first control signal (V) comprises:
(i) removing an analog output wire from the rod pumping control unit, and connecting the output wire to an input bus in the pump stroke controller; or
(ii) removing a ModBus connection from the rod pumping control unit and re-routing the first control signal (V) to the pump stroke controller.

50. The method of claim 48, further comprising:
intercepting first control signals (V) at least each second;
summing the first control signals (V) over a period of time (Q) to arrive at a sum (K);
dividing (K) by (Q) to generate the second control signal (Av); and
resetting (K) and (Q) as “0”.

51. The method of claim 50, further comprising:
allowing the rod pumping control unit to run for a period of at least 24 hours before making any speed adjustments;
inferring a pre-set maximum working speed (X) and minimum working speed (Y) of the rod pumping control unit by observing maximum stroke speeds and minimum stroke speeds during the at least 24 hours time period; and
at each pre-selected time, setting the upstroke speed (U) of each pump cycle to be:
(U)=(X)_−(Av); and
at each pre-selected time, setting the downstroke speed (D) of each pump cycle to be the greater of (i) the minimum working speed (Y), or the value derived by subtracting a pre-set drop-down value (Z) from (U), wherein (Z) is between 20 and 33 Hertz.
